(19) United States
(12) Patent Application Publication
(10) Pub. No.: US 2026/0059172 A1
(43) Pub. Date: Feb. 26, 2026

(54) DISPLAY APPARATUS AND METHOD OF OPERATING THE SAME

(71) Applicant: Samsung Electronics Co., Ltd., Suwon-si (KR)

(72) Inventors: Donguk KIM, Suwon-si (KR); Sehyun KIM, Suwon-si (KR); Yeonwoo KIM, Suwon-si (KR); Jongin LEE, Suwon-si (KR); Donghwa JEONG, Suwon-si (KR)

(73) Assignee: Samsung Electronics Co., Ltd., Suwon-si (KR)

(21) Appl. No.: 19/309,134

(22) Filed: Aug. 25, 2025

Related U.S. Application Data
(63) Continuation of application No. PCT/KR2025/008922, filed on Jun. 25, 2025.

(30) Foreign Application Priority Data
Aug. 26, 2024 (KR) 10-2024-0114485

(51) Int. Cl. H04N 21/482; H04N 21/431

(52) U.S. Cl. CPC H04N 21/4828; H04N 21/4316

(57) ABSTRACT

A display apparatus includes: a display; memory storing one or more instructions; and at least one processor configured to execute the one or more instructions to: control the display to display a home screen including one or more content lists arranged in a row, based on a search for a first keyword, obtain a search result for the first keyword, the search result including one or more image content items corresponding to the first keyword, add, to the one or more content lists arranged in the row, a first content list including the one or more image content items corresponding to the first keyword, and control the display to display the home screen including the first content list.

### CROSS-REFERENCE TO RELATED APPLICATION(S)

This application is a continuation of International Application No. PCT/KR2025/008922, filed on Jun. 25, 2025, in the Korean Intellectual Property Receiving Office, which is based on and claims priority to Korean Patent Application No. 10-2024-0114485, filed on Aug. 26, 2024, in the Korean Intellectual Property Office, the disclosures of which are incorporated by reference herein in their entireties.

### BACKGROUND

### 1. Field

The disclosure relates to a display apparatus capable of providing a home screen, and a method of operating the same.

### 2. Description of Related Art

With the technological development of display apparatuses, various display apparatuses capable of implementing diverse functions have been developed.

A display apparatus may include a television (TV). Related-art TVs merely perform the function of receiving broadcast signals and reproducing corresponding broadcast content (e.g., news, dramas, or entertainment programs).

Recently, with the technological development of display apparatuses, various applications or programs may be stored and installed on a TV to perform various functions, and through the installed applications, various functions and services may be provided in addition to a broadcast content reproduction function.

In addition, a TV may have a home screen provided by the TV itself, and when the TV is turned on, the home screen may be automatically executed. For example, the home screen may include an advertisement area that displays advertising content, as well as various functions and menus. The home screen may include a search menu, and the TV may perform a search for a keyword input by a user based on the search menu, and display search results. When the user selects an image content item included in the search results, an application corresponding to the selected image content item may be automatically executed to reproduce the image content item.

In this case, when the reproduction of the image content item ends, a home screen of the application may be displayed, preventing the user from viewing other image content items included in the search results. Furthermore, because the search results for the previously searched keyword are no longer displayed, the user may need to repeat the search for the same keyword to find other image content items associated with the previously searched keyword.

### SUMMARY

Aspects will be set forth in part in the description which follows and, in part, will be apparent from the description, or may be learned by practice of the presented embodiments.

According to an aspect of the disclosure, a display apparatus may include: a display; memory storing one or more instructions; and at least one processor configured to execute the one or more instructions to: control the display to display a home screen including one or more content lists arranged in a row, based on a search for a first keyword, obtain a search result for the first keyword, the search result including one or more image content items corresponding to the first keyword, add, to the one or more content lists arranged in the row, a first content list including the one or more image content items corresponding to the first keyword, and control the display to display the home screen including the first content list.

The at least one processor may be further configured to execute the one or more instructions to: reproduce a first image content item among the one or more image content items corresponding to the first keyword, and based on the reproduction of the first image content item being terminated or based on a preset user input being received, control the display to display the home screen including the first content list.

The at least one processor may be further configured to execute the one or more instructions to: execute an application corresponding to the first image content item, reproduce the first image content item based on executing the application, and in a state in which the application is being executed, identify whether the reproduction of the first image content item is terminated or whether the preset user input is received.

The preset user input may include at least one of an input requesting termination of the first image content item, an input requesting to return to a previous screen, or an input requesting the home screen.

The home screen may include a search menu corresponding to a search function, where the at least one processor is further configured to execute the one or more instructions to: display a search screen based on a user input selecting the search menu, and based on the search for the first keyword, control the display to display, on the search screen, the search result for the first keyword.

The at least one processor may be further configured to execute the one or more instructions to control the display to overlay the search screen on the home screen.

The home screen may include a target area, where the at least one processor is further configured to execute the one or more instructions to control the display to display targeted content in the target area.

The at least one processor may be further configured to execute the one or more instructions to: obtain a second search result for a second keyword, the second search result including one or more image content items corresponding to the second keyword, add, to the one or more content lists arranged in the row, a second content list including the one or more image content items corresponding to the second keyword, and control the display to display the home screen including the second content list.

The at least one processor may be further configured to execute the one or more instructions to: control the display to display, on the home screen, a keyword list including the first keyword and the second keyword, based on a user input selecting the first keyword, control the display to display only the first content list, among the first content list and the second content list, and based on a user input selecting the second keyword, control the display to display only the second content list, among the first content list and the second content list.

The at least one processor may be further configured to execute the one or more instructions to: reproduce a second image content item, based on a user input selecting the second image content item among the one or more image content items included in the first content list or the second content list.

The at least one processor may be further configured to execute the one or more instructions to: control the display to display, on the home screen, a content provider list including a plurality of content providers, and based on an input selecting a content provider among the plurality of content providers, control the display to display, in the first content list, only image content items corresponding to the selected content provider, among the one or more image content items corresponding to the first keyword.

The at least one processor may be further configured to execute the one or more instructions to: based on a user input, set at least one of: whether to display, on the home screen, a content list including one or more image content items corresponding to a searched keyword, a display format of the content list, or a number of content items in the content list.

According to an aspect of the disclosure, a method of operating a display apparatus may include: displaying a home screen including one or more content lists arranged in a row; based on a search for a first keyword, obtaining a search result for the first keyword, the search result including one or more image content items corresponding to the first keyword; adding, to the one or more content lists arranged in the row, a first content list including the one or more image content items corresponding the first keyword; and displaying the home screen including the first content list.

The method may further include: reproducing a first image content item among the one or more image content items corresponding to the first keyword; and based on the reproduction of the first image content item being terminated or based on a preset user input being received, displaying the home screen including the first content list.

The reproducing the first image content item may include: executing an application corresponding to the first image content item; and reproducing the first image content item based on executing the application, where the method further includes, in a state in which the application is being executed, identifying whether the reproduction of the first image content item is terminated or whether the preset user input is received.

The preset user input may include at least one of an input requesting termination of the first image content item, an input requesting to return to a previous screen, or an input requesting the home screen.

The home screen may include a target area, where the method further includes displaying targeted content in the target area.

The method may further include: obtaining a second search result for a second keyword, the second search result including one or more image content items corresponding to the second keyword; adding, to the one or more content lists arranged in the row, a second content list including the one or more image content items corresponding to the second keyword; and displaying the home screen including the second content list.

The method may further include: displaying, on the home screen, a keyword list including the first keyword and the second keyword; based on a user input selecting the first keyword, displaying only the first content list, among the first content list and the second content list; and based on a user input selecting the second keyword, displaying only the second content list, among the first content list and the second content list.

According to an aspect of the disclosure, a non-transitory computer-readable recording medium may have stored therein a program that, when executed by one or more or more processors, executes a method including: displaying a home screen including one or more content lists arranged in a row; based on a search for a first keyword, obtaining a search result for the first keyword, the search result including one or more image content items corresponding to the first keyword; adding, to the one or more content lists arranged in the row, a first content list including the one or more image content items corresponding the first keyword; and displaying the home screen including the first content list.

According to an aspect of the disclosure, a display apparatus may include: a display; memory storing one or more instructions; and at least one processor configured to execute the one or more instructions to: control the display to display a home screen including: a menu area including a search menu corresponding to a search function, an application area including a list of one or more applications providing content, a search history area including one or more content lists arranged in a row, based on a search for a first keyword, obtain a search result for the first keyword, the search result including one or more image content items corresponding to the first keyword, add, to the one or more content lists arranged in the row, a first content list including the one or more image content items corresponding to the first keyword, and control the display to display the home screen including the first content list.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a display apparatus according to an embodiment of the disclosure;

FIG. 2 is a flowchart of a method of operating a display apparatus according to an embodiment of the disclosure;

FIG. 3, FIG. 4, FIG. 5, and FIG. 6 are diagrams for describing operations performed by a display apparatus in cases in which a search history area is not provided on a home screen and cases in which a search history area is provided on a home screen, according to one or more embodiments of the disclosure;

FIG. 7 and FIG. 8 are diagrams illustrating an example in which a display apparatus displays a search history area on a home screen, according to one or more embodiments of the disclosure;

FIG. 9 is a diagram illustrating an example in which a display apparatus displays a search history area on a home screen, according to an embodiment of the disclosure;

FIG. 10 and FIG. 11 are diagrams illustrating an example in which a display apparatus displays a search history area on a home screen, according to one or more embodiments of the disclosure.

FIG. 12 and FIG. 13 are diagrams illustrating an example in which a display apparatus displays a search history area on a home screen, according to one or more embodiments of the disclosure;

FIG. 14 and FIG. 15 are diagrams illustrating an example in which a display apparatus displays a search history area on a home screen, according to one or more embodiments of the disclosure;

FIG. 16 is a diagram illustrating an example in which a display apparatus displays a search window, according to an embodiment of the disclosure;

FIG. 17 is a diagram illustrating an example in which a display apparatus displays, in a search history area of a home screen, a result of a search performed by an external electronic device, according to an embodiment of the disclosure;

FIG. 18 is a diagram illustrating an example in which a display apparatus displays a home screen setting menu, according to an embodiment of the disclosure;

FIG. 19 is a block diagram illustrating a configuration of a display apparatus according to an embodiment of the disclosure; and

FIG. 20 is a block diagram illustrating a configuration of a display apparatus according to an embodiment of the disclosure.

### DETAILED DESCRIPTION

The terms used herein will be briefly described, and then the disclosure will be described in detail.

Although the terms used herein are selected from among common terms that are currently widely used in consideration of their functions in the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding part of the detailed description. Therefore, the terms used herein are not merely designations of the terms, but the terms are defined based on the meaning of the terms and content throughout the disclosure.

Throughout the specification, when a part “includes”, “has”, or “comprises” a component, it means that the part may additionally include other components rather than excluding other components as long as there is no particular opposing recitation. In addition, as used herein, the terms such as “ . . . er (or)”, “ . . . unit”, “ . . . module”, etc., denote a unit that performs at least one function or operation, which may be implemented as hardware or software or a combination thereof.

Hereinafter, embodiments of the disclosure will be described with reference to the accompanying drawings in such a manner that the embodiments may be easily carried out by those of skill in the art. The disclosure may, however, be embodied in many different forms and should not be construed as being limited to embodiments set forth herein. In order to clearly describe the disclosure, portions that are not relevant to the description of the disclosure are omitted in the drawings, and similar reference numerals are assigned to similar elements throughout the specification.

In an embodiment of the specification, the term “user” refers to a person who controls systems, functions, or operations, and may include a developer, an administrator, or an installer.

In addition, in an embodiment of the disclosure, the term ‘image’ or ‘picture’ may refer to a still image, a moving image consisting of a plurality of continuous still images (or frames), or a video.

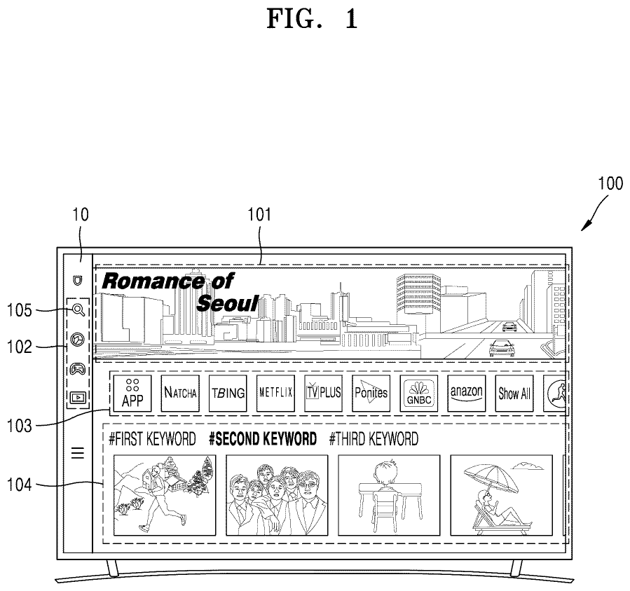

FIG. 1 is a diagram illustrating a display apparatus according to an embodiment of the disclosure.

Referring to FIG. 1, a display apparatus 100 according to an embodiment of the disclosure may be a television (TV), but this is merely an example embodiment of the disclosure, and the display apparatus 100 may be implemented in various forms that include a display. For example, the display apparatus 100 may be implemented in various forms such as a mobile phone, a tablet personal computer (PC), a digital camera, a camcorder, a laptop computer, a desktop computer, an electronic book terminal, a digital broadcast terminal, a personal digital assistant (PDA), a portable multimedia player (PMP), a navigation system, an MP3 player, or a wearable device.

In addition, the display apparatus 100 may be a stationary electronic apparatus arranged in a fixed location or a mobile electronic apparatus having a portable form, and may be a digital broadcast receiver capable of receiving digital broadcasts. In particular, embodiments of the disclosure may be readily implemented in display apparatuses with large displays, such as TVs, but are not limited thereto.

The display apparatus 100 may be implemented not only as a flat display apparatus but also as a curved display apparatus having a screen with a curvature, or as a flexible display apparatus with an adjustable curvature. The output resolution of the display apparatus 100 may include, for example, high definition (HD), full HD, ultra HD, or a resolution higher than ultra HD.

The display apparatus 100 according to an embodiment of the disclosure may display a home screen 10 when the display apparatus 100 is powered on. Here, the home screen 10 is a menu screen provided by the display apparatus 100, and may be displayed as a full screen or on a portion of a screen.

The home screen 10 according to an embodiment of the disclosure may include a target area 101 that displays targeted content. For example, as illustrated in FIG. 1, the target area 101 may be located in an upper region of the home screen 10, but is not limited thereto, and may have various positions and sizes. The display apparatus 100 may provide a user with targeted content via the target area 101.

The home screen 10 according to an embodiment of the disclosure may include a menu area 102 that includes various functions and menus. For example, the display apparatus 100 may display, in the menu area 102, items such as a search button (or search icon) 105 corresponding to a search function. However, the disclosure is not limited thereto.

The display apparatus 100 according to an embodiment of the disclosure may display, on the home screen 10, a content list including one or more content items. The display apparatus 100 may display the home screen 10, where one or more content lists are arranged in rows.

For example, the content lists may include an application list 103. The display apparatus 100 according to an embodiment of the disclosure may display, on the home screen 10, the application list 103 indicating applications that are pre-installed or installable on the display apparatus 100. By selecting one of the items included in the application list 103, the user may readily execute an application corresponding to the selected item. According to an embodiment, at least some of the applications in the application list may be platforms for providing content. For example, at least some of the applications may include Netflix™, AppleTV™, YouTube™ or YouTubeTV™, PrimeVideo™, or the like. However, these are merely examples, and the disclosure is not limited thereto. The applications may be referred to as “content providers.”

According to an embodiment of the disclosure, the content lists may include an image content list indicating one or more image content items. The display apparatus 100 according to an embodiment of the disclosure may display, on the home screen 10, a content list that includes thumbnails representing recently viewed image content, image content currently being broadcast, recommended image content, and the like. Accordingly, by selecting any one of the thumbnails included in the content list, the user may readily reproduce an image content item corresponding to the selected thumbnail.

The display apparatus 100 according to an embodiment of the disclosure may display a search history area 104 on the home screen 10. The search history area 104 may be generated after a search for a keyword has been performed. For example, when the user selects the search button (or search icon) 105 included in the menu area 102 by using a control device or the like, a search screen or a search window may be displayed. The user may input a keyword on the search screen or search window by using a keypad of the control device or the like, or may input a keyword through voice input or the like. However, the disclosure is not limited thereto.

The display apparatus 100 according to an embodiment of the disclosure may perform a search for the keyword input by the user, and obtain a search result. For example, the display apparatus 100 may transmit, to a server, a search request for the keyword input by the user. The server may perform a search for the keyword and obtain a search result. The display apparatus 100 may receive the search result from the server.

After the search has been performed, the display apparatus 100 may add or display the search history area 104 on the home screen 10. The search history area 104 may include the keyword for which the search has been performed, and the search result for the keyword. The search result for the keyword may include one or more image content items associated with the keyword. The search history area 104 may include a content list including one or more image content items associated with the keyword, and the content list may be arranged and displayed in a row. However, the disclosure is not limited thereto.

According to an embodiment of the disclosure, by displaying the search history area 104 on the home screen 10, the display apparatus 100 may provide a search result for a keyword that has been previously searched for. Accordingly, the user does not need to repeat the search for the same keyword and may quickly find and execute a desired image content item based on a past search result.

Hereinafter, operations, performed by which the display apparatus 100, of providing the search history area 104 on the home screen 10, according to an embodiment of the disclosure, will be described in detail with reference to the accompanying drawings.

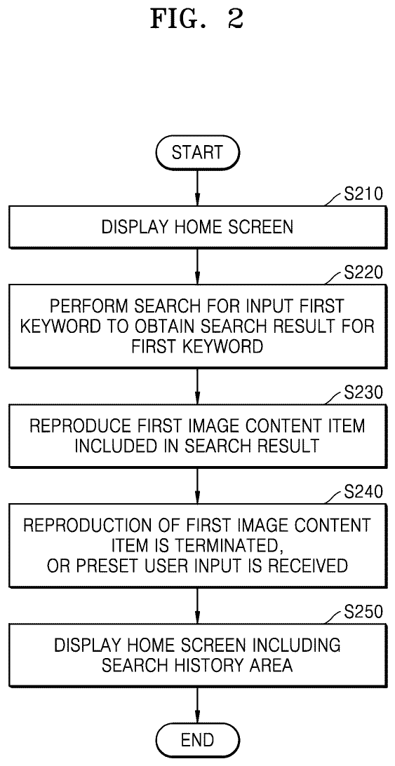

FIG. 2 is a flowchart of a method of operating a display apparatus according to an embodiment of the disclosure.

Referring to FIG. 2, the display apparatus according to an embodiment of the disclosure may display a home screen (S210).

According to an embodiment of the disclosure, the home screen is a menu screen provided by the display apparatus 100, and may be displayed as a full screen or on a portion of a screen. The home screen may include a target area that displays targeted content, a menu area that displays functions or menus provided by the display apparatus 100, an application list indicating one or more applications installed or installable on the display apparatus 100, a content list including recommended content, image content currently being broadcast, and recently viewed content, etc. However, the disclosure is not limited thereto.

The display apparatus 100 may provide a search function, and a search button (or search icon) may be displayed in the menu area of the home screen. When the user selects a search button or the like included in the menu area by using a control device or the like, a search screen or a search window may be displayed. The user may input a keyword on the search screen or search window by using a keypad of the control device or the like, or may input a keyword through voice input or the like. However, the disclosure is not limited thereto.

The display apparatus 100 according to an embodiment of the disclosure may perform a search for an input first keyword and obtain a search result for the first keyword (S220).

The display apparatus 100 according to an embodiment of the disclosure may display the search result for the first keyword. For example, the search result for the first keyword may include one or more image content items associated with the first keyword. The display apparatus 100 may display, as thumbnails, the one or more image content items associated with the first keyword. A thumbnail may be a small image representing image content and may be used for preview purposes. In addition, a thumbnail may be an image that allows a viewer to check an outline of the corresponding content, and may include an image representing a key scene of the image content. However, the disclosure is not limited thereto.

The display apparatus 100 according to an embodiment of the disclosure may receive a user input for selecting a first image content item from among the one or more image content items included in the search result. For example, the display apparatus 100 may receive an input involving selecting a thumbnail corresponding to the first image content item from among one or more thumbnails by using arrow keys included in a control device, and pressing a particular key. Alternatively, the display apparatus 100 may receive, from the user, a voice input, a gesture input, or the like for selecting the first image content item. However, the disclosure is not limited thereto.

According to an embodiment of the disclosure, based on the user input for selecting the first image content item, the display apparatus 100 may reproduce the first image content item (S230).

For example, the display apparatus 100 may execute an application corresponding to the first image content item, and reproduce the first image content item by using the executed application. The display apparatus 100 may display a reproduction screen for the first image content item. The display apparatus 100 may reproduce the first image content item based on deep link information or reproduction information about the first image content item. Deep link information may include address information or a link allowing direct access to an image content item (e.g., allowing reproduction of the image content item) without going through a homepage (or a home screen) of an application or a server for reproducing the image content item.

According to an embodiment of the disclosure, based on the reproduction of the first image content item being terminated or based on a preset user input being received (S240), the display apparatus 100 may display a home screen including a search history area (S250).

The display apparatus 100 according to an embodiment of the disclosure may monitor whether the first image content item is terminated while the first image content item is reproduced or while an application corresponding to the first image content item is executed, and whether a key input corresponding to a ‘go-back’ action (e.g., a return key or a back key) or an input for requesting the home screen is received during the reproduction of the first image content item.

The display apparatus 100 may detect that the reproduction of the first image content item is terminated, or may receive a key input corresponding to a ‘go-back’ action (e.g., a return key or a back key) or an input for requesting a home screen during the reproduction of the first image content item. When the reproduction of the first image content item is terminated, or when the display apparatus 100 receives a key input corresponding to a ‘go-back’ action or an input for requesting a home screen, the display apparatus 100 may display the home screen. Here, the home screen may include a search history area. According to an embodiment of the disclosure, the search history area may be an area in which a keyword for which a search has been previously performed, and a search result for the keyword are displayed.

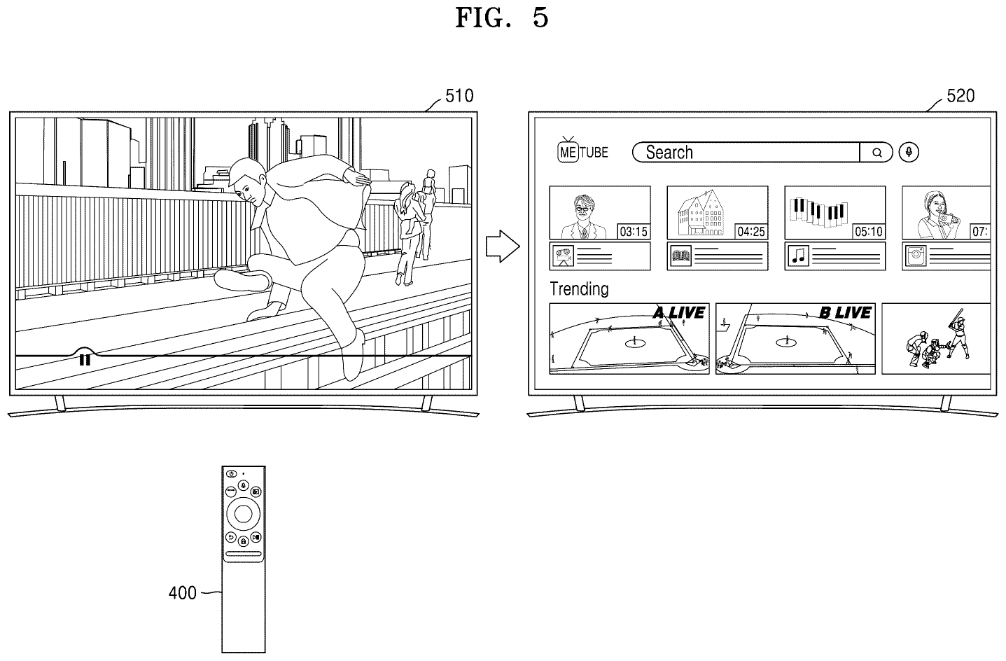

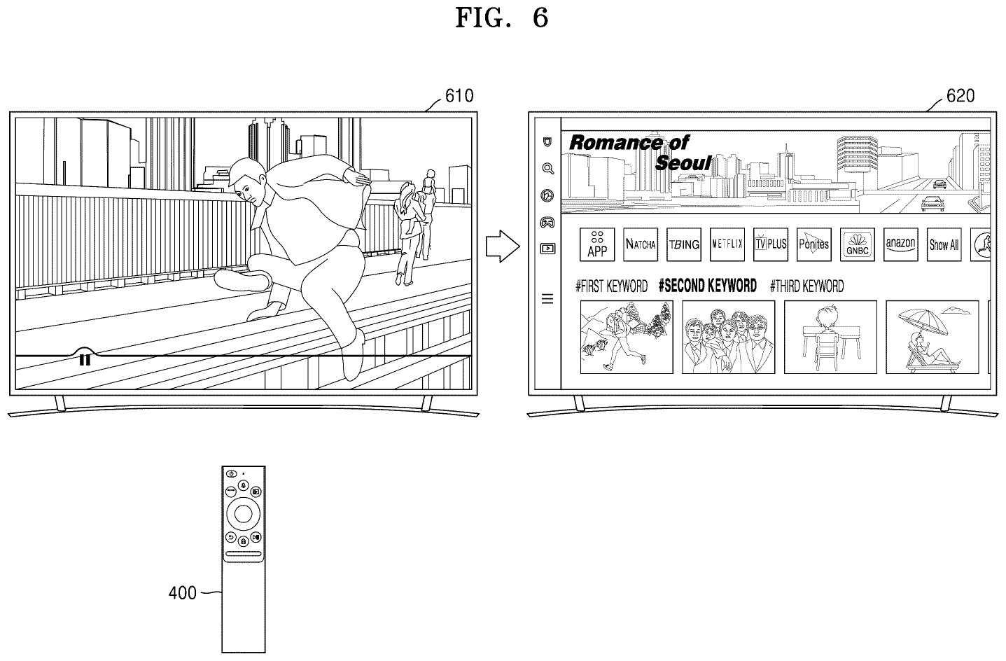

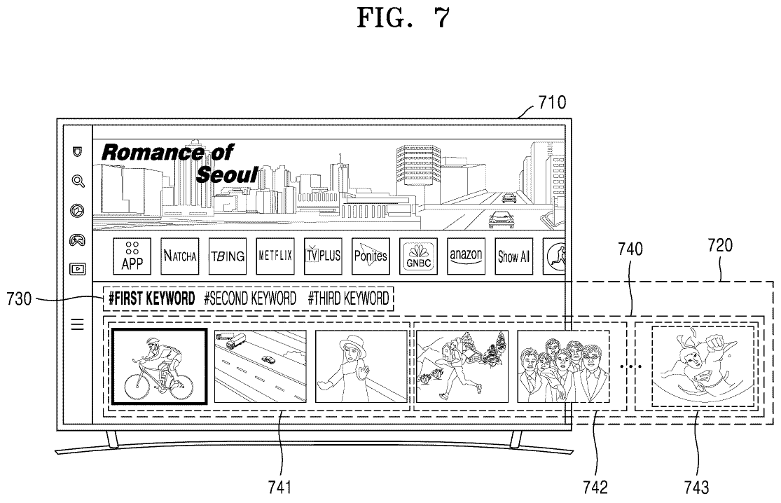

A method of displaying a search history area according to an embodiment of the disclosure will be described in detail below with reference to FIGS. 7 to 15.

According to an embodiment of the disclosure, by using the search history area, the display apparatus 100 may quickly find desired information (e.g., image content) based on a past search result, without needing to repeat a search for a previously searched keyword.

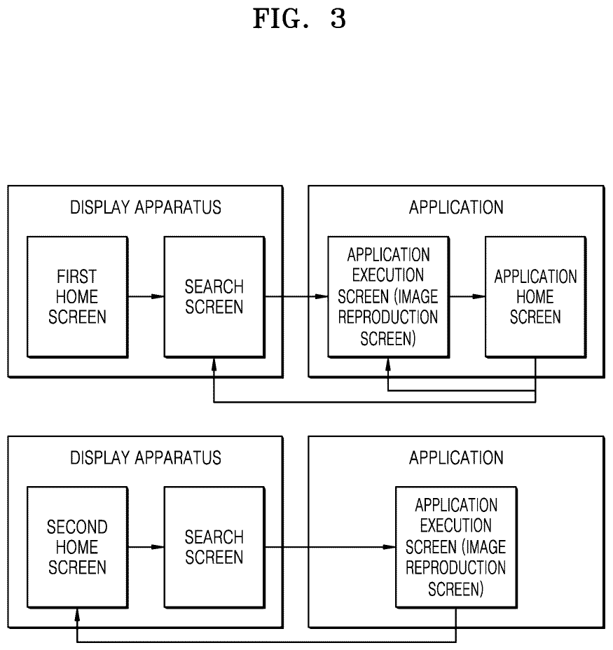

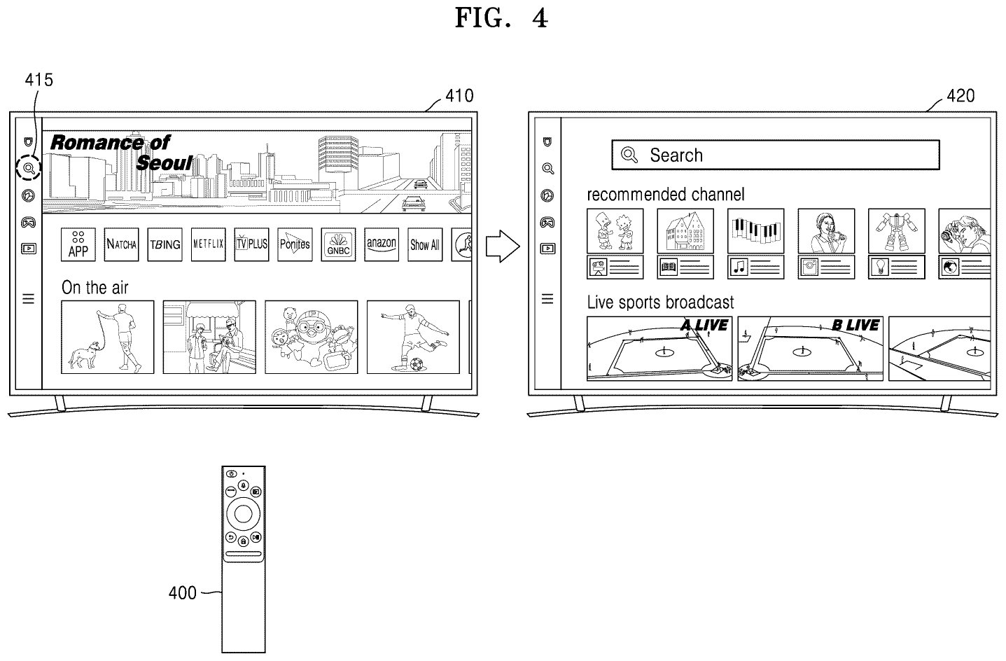

FIGS. 3 to 6 are diagrams for describing operations performed by a display apparatus in cases in which a search history area is not provided on a home screen and cases in which a search history area is provided on a home screen, according to an embodiment of the disclosure.

In FIG. 3, a first home screen may represent a home screen where a search history area is not provided, and a second home screen may represent a home screen where a search history area is provided.

Referring to FIGS. 3 and 4, the display apparatus 100 may display a first home screen and a second home screen 410. The first home screen and the second home screen 410 may include a content list including one or more content items. One or more content lists may be arranged in rows on the first home screen and the second home screen 410. For example, the content lists may include a list indicating one or more applications, and an image content list including one or more image content items (e.g., recently viewed image content items, image content items currently being broadcast, or recommended image content items). However, the disclosure is not limited thereto.

According to an embodiment of the disclosure, the first home screen and the second home screen 410 provided by the display apparatus 100 may provide a search function. For example, when a search icon 415 corresponding to the search function provided on the first home screen and the second home screen 410 is selected by using a control device 400 or the like, the display apparatus 100 may display a search screen 420. For example, the search screen 420 may include a keyword input field in which a search keyword may be input, a search request button, and the like. In addition, the search screen 420 may include an area that displays a search result after a search for the keyword has been performed. However, the disclosure is not limited thereto. The search result may include one or more image content items associated with the keyword, and may include deep link information about each of the image content items. For example, deep link information may include address information or a link allowing direct access to an image content item (e.g., allowing reproduction of the image content item) without going through a homepage (or a home screen) of an application or a server for reproducing the image content item.

According to an embodiment of the disclosure, the first home screen, the second home screen 410, and the search screen 420 may be user interface screens provided by the display apparatus 100 according to an embodiment of the disclosure.

When an input for selecting any one of the one or more image content items included in the search result is received, the display apparatus 100 may reproduce the selected image content item.

Referring to FIGS. 3, 5, and 6, the display apparatus 100 may execute an application for reproducing the selected image content item. By using the executed application, the display apparatus 100 may reproduce the image content item and display a reproduction screen 510 or 610 for the image content item.

Referring to FIG. 5, in a case in which a search history area is not provided on a home screen (e.g., the first home screen), when the reproduction of the image content item is terminated or when a preset input is received, the display apparatus 100 may stop displaying the reproduction screen 510 for the image content item and display a home screen 520 of the application, or the search screen.

According to an embodiment of the disclosure, the preset input may include a key input corresponding to a ‘go-back’ action (e.g., a return key or a back key of the control device 400) or an input for requesting the home screen.

The home screen 520 of the application may display a content list including one or more recommended content items provided by the application, content items currently being viewed via the application, previously viewed content items, and the like. However, the disclosure is not limited thereto.

In addition, the home screen 520 of the application may provide a search function, and by performing a search for a keyword by using the search function provided on the home screen of the application, it is possible to search for content items associated with the keyword from among the content items provided by the application.

According to an embodiment of the disclosure, the execution screen of the application (e.g., a reproduction screen for image content) and the home screen of the application may be user interface screens provided by the application.

When the home screen of the application is displayed, the user may make an additional input such that a search screen or a home screen provided by the display apparatus 100 is displayed. In addition, even when the search screen or the home screen is displayed, a search result for a previously searched keyword is not displayed, and thus, there may be the inconvenience that a search needs to be repeated to obtain a search result for the previously searched keyword.

On the contrary, referring to FIG. 6, when the display apparatus 100 according to an embodiment of the disclosure provides a search history area on a home screen (e.g., the second home screen), the display apparatus 100 may monitor, while an application for reproducing an image content item is executed, whether the reproduction of the image content item is terminated or whether a preset input is received.

When the reproduction of the image content item is terminated or when a preset input is received, the display apparatus 100 may stop displaying the reproduction screen 610 for the image content item and display a home screen 620 including a search history area.

According to an embodiment of the disclosure, the home screen 620 may include the search history area. According to an embodiment of the disclosure, the search history area may be an area in which a keyword for which a search has been previously performed, and a search result for the keyword are displayed. For example, the search history area may include a content list including one or more image content items associated with a keyword for which a search has been performed, and the content list may be arranged and displayed in a row. In addition, the display apparatus 100 may display, in the content list, the one or more image content items associated with the keyword for which the search has been performed, in a thumbnail format. A method of displaying a search history area according to an embodiment of the disclosure will be described in detail below with reference to FIGS. 7 to 15.

According to an embodiment of the disclosure, when an input for selecting a thumbnail included in the search history area is received, the display apparatus 100 may reproduce an image content item corresponding to the selected thumbnail, based on deep link information about the corresponding image content item.

Accordingly, by using the search history area, the user may readily find or view image content items associated with a previously searched keyword without performing repetitive searches.

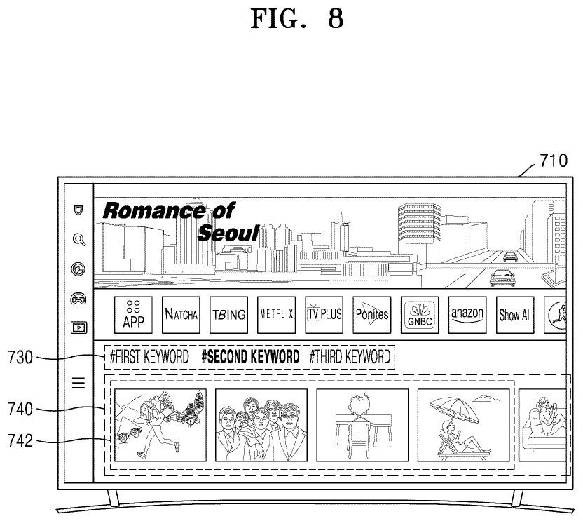

FIGS. 7 and 8 are diagrams illustrating an example in which a display apparatus displays a search history area on a home screen, according to one or more embodiments of the disclosure.

Referring to FIG. 7, the display apparatus 100 according to an embodiment of the disclosure may display a home screen 710. The home screen 710 may include target area, a menu area, an application list, and the like. According to an embodiment of the disclosure, the application list may be arranged and displayed in a row on the home screen 710. According to an embodiment of the disclosure, the home screen 710 may include a search history area 720. For example, in a case in which there is a history of searches that have been performed, the display apparatus 100 may display the search history area 720 on the home screen 710.

The search history area 720 may include keywords that have been searched for by the user, and search results for the keywords. For example, as illustrated in FIG. 7, the search history area 720 may include a keyword list 730 including keywords that have been searched for by the user.

According to an embodiment of the disclosure, the keywords included in the keyword list 730 may be displayed based on the order in which the searches were performed. Based on the order in which the searches were performed, the display apparatus 100 may display the keywords such that keywords that were searched for earlier are displayed toward the top of the list. For example, when searches were performed in the order of a first keyword, a second keyword, and a third keyword, the display apparatus 100 may display the keywords in the keyword list 730 in the order of the first keyword, the second keyword, and the third keyword.

According to an embodiment of the disclosure, based on the order in which the searches were performed, the display apparatus 100 may display the keywords such that keywords that were searched for more recently are displayed toward the top of the keyword list. For example, when searches were performed in the order of a first keyword, a second keyword, and a third keyword, the display apparatus 100 may display the keywords in the keyword list 730 in the order of the third keyword, the second keyword, and the first keyword.

The display apparatus 100 may display a hashtag before each keyword, such that the keywords may be readily distinguished. The display apparatus 100 may display the keywords in the form of a bubble user interface. A bubble user interface refers to an interface in which a message or information is represented by a bubble-shaped element. However, the disclosure is not limited thereto, and the keywords may be displayed in various forms.

According to an embodiment of the disclosure, the number of keywords displayed in the keyword list 730 may be preset or may be set based on a user input. In addition, when the keywords included in the keyword list 730 cannot all be displayed on a single screen, the display apparatus 100 may display keywords that were not previously displayed on the screen, based on an input for horizontally scrolling the keyword list 730. However, the disclosure is not limited thereto.

According to an embodiment of the disclosure, the search history area 720 may include a content list 740 including one or more content items associated with the keywords. According to an embodiment of the disclosure, the content list 740 may be arranged and displayed in a row. The one or more image content items associated with the keywords may be image content items that are included in search results previously obtained via keyword searches.

The display apparatus 100 according to an embodiment of the disclosure may display, in the content list 740, the one or more content items in a thumbnail format.

The display apparatus 100 according to an embodiment of the disclosure may display the content items included in the content list 740, based on the order in which the searches were performed. Based on the order in which the searches were performed, the display apparatus 100 may display the content items such that content items associated with keywords that were searched for earlier are displayed toward the top of the content list 740. For example, when searches were performed in the order of a first keyword, a second keyword, and a third keyword, the display apparatus 100 may display content items in the content list 740 in the order of content items 741 associated with the first keyword, content items 742 associated with the second keyword, and content items 743 associated with the third keyword.

According to an embodiment of the disclosure, based on the order in which the searches were performed, the display apparatus 100 may display the content items such that content items associated with keywords that were searched for more recently are displayed toward the top of the content list 740. For example, when searches were performed in the order of the first keyword, the second keyword, and the third keyword, the display apparatus 100 may display content items in the content list 740 in the order of the content items 743 associated with the third keyword, the content items 742 associated with the second keyword, and the content items 741 associated with the first keyword. However, the disclosure is not limited thereto.

The display apparatus 100 according to an embodiment of the disclosure may display, from among the one or more content items included in the content list 740, a content item that the user has previously viewed, such that it is distinguished from other content items. For example, the display apparatus 100 may indicate a previously viewed content item by displaying a bold line on the border of the thumbnail corresponding to the previously viewed content item, by highlighting the thumbnail corresponding to the previously viewed content item, or by displaying a mark or indicator on the thumbnail corresponding to the previously viewed content item to indicate that the image content item has been viewed, but the disclosure is not limited thereto.

According to an embodiment of the disclosure, when the one or more content items included in the content list 740 cannot all be displayed on a single screen, the display apparatus 100 may display content items that were not previously displayed on the screen, based on an input for horizontally scrolling the content list 740. However, the disclosure is not limited thereto. For example, referring to FIG. 7, in a state in which the content items 741 associated with the first keyword and some of the content items 742 associated with the second keyword are displayed, the display apparatus 100 may receive an input for scrolling the content list 740 to the left and display the content items 743 associated with the third keyword.

Referring to FIG. 8, according to an embodiment of the disclosure, when any one of the keywords included in the keyword list 730 is selected, the display apparatus 100 may scroll and display the content list 740 such that content items associated with the selected keyword are displayed on the screen. For example, when the second keyword included in the keyword list 730 is selected, the display apparatus 100 may scroll and display the content list 740 such that the content items 742 associated with the second keyword are displayed on the screen.

According to an embodiment of the disclosure, when any one of the keywords included in the keyword list 730 is selected, the display apparatus 100 may display, in the content list 740, only content items associated with the selected keyword. For example, when the second keyword included in the keyword list 730 is selected, the display apparatus 100 may display, in the content list, only the content items 742 associated with the second keyword.

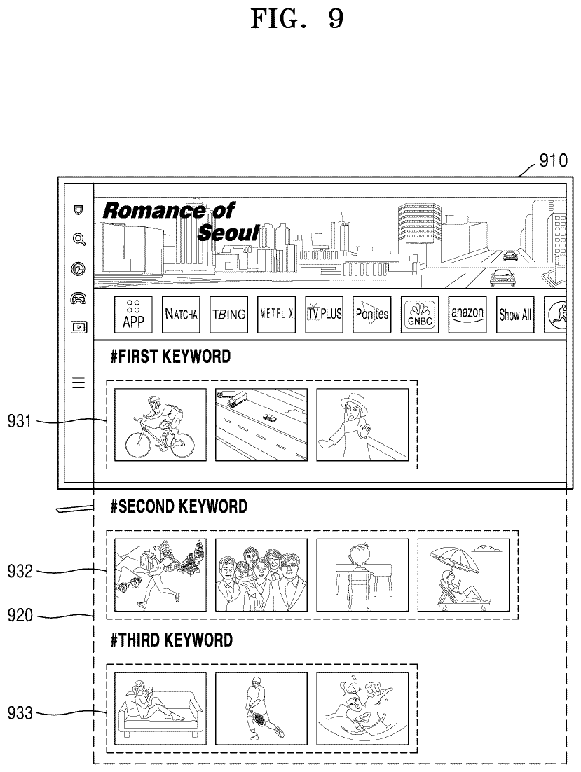

FIG. 9 is a diagram illustrating an example in which a display apparatus displays a search history area on a home screen, according to an embodiment of the disclosure.

Referring to FIG. 9, when there is a history of searches that have been performed, the display apparatus 100 according to an embodiment of the disclosure may display a search history area 920 on a home screen 910.

The search history area 920 may include keywords that have been searched for by the user, and search results for the keywords. For example, as illustrated in FIG. 9, the search history area 920 may include keywords previously searched for by the user, and content lists 931, 932, and 933 each including one or more content items associated with the corresponding keyword. The one or more image content items associated with each of the keywords may be image content items that are included in a search result previously obtained via a keyword search. The display apparatus 100 may display, in the content lists 931, 932, and 933, the one or more content items in a thumbnail format.

Based on the order in which the searches were performed, the display apparatus 100 may display the content lists such that content lists associated with keywords that were searched for more recently are displayed toward the top of the search history area 920. For example, when searches were performed in the order of a first keyword, a second keyword, and a third keyword, the display apparatus 100 may display the content lists in the search history area 920 in the order of the content list 931 associated with the first keyword, the content list 932 associated with the second keyword, and the content list 933 associated with the third keyword. However, the disclosure is not limited thereto, and the keywords and the content list associated with the keywords may be displayed in the search history area 920 based on various criteria.

According to an embodiment of the disclosure, the numbers of keywords and content lists associated with the keywords displayed in the search history area 920 may be preset or may be set based on a user input. In addition, when the keywords and the content lists associated with the keywords, which are included in the search history area 920, cannot all be displayed on a single screen, the display apparatus 100 may display keywords and content lists associated with the keywords that were not previously displayed on the screen, based on an input for vertically scrolling. However, the disclosure is not limited thereto.

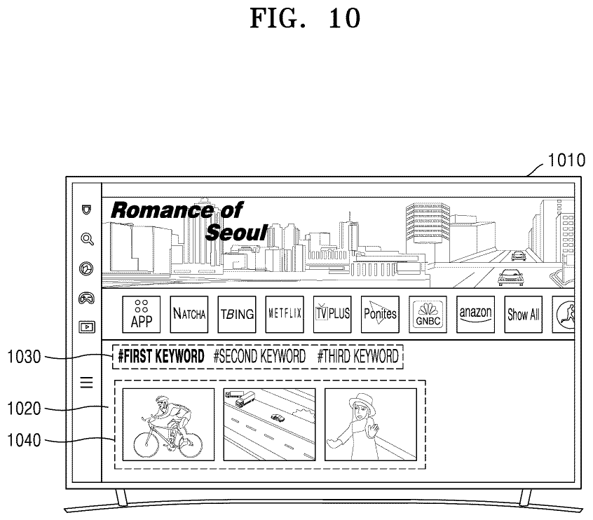

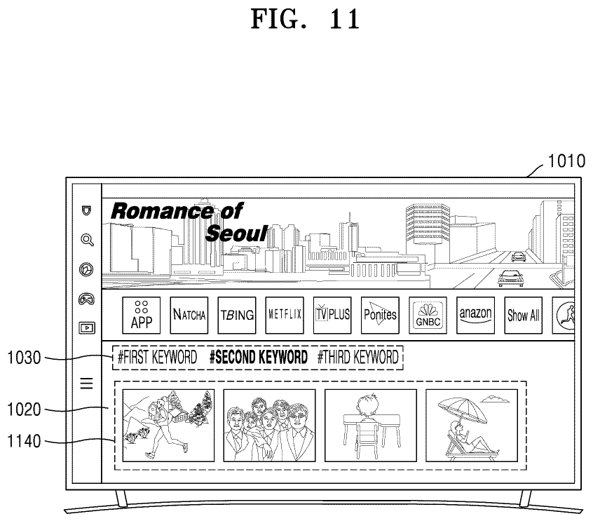

FIGS. 10 and 11 are diagrams illustrating an example in which a display apparatus displays a search history area on a home screen, according to one or more embodiments of the disclosure.

Referring to FIG. 10, when there is a history of searches that have been performed, the display apparatus 100 according to an embodiment of the disclosure may display a search history area 1020 on a home screen 1010.

The search history area 1020 may include keywords that have been searched for by the user, and search results for the keywords. For example, as illustrated in FIG. 10, the search history area 1020 may include a keyword list 1030 including keywords previously searched for by the user, and a content list 1040 including one or more image content items associated with each of the keywords. The one or more image content items associated with each of the keywords may be image content items that are included in a search result previously obtained via a keyword search. The content list 1040 may include thumbnails respectively representing the one or more content items.

According to an embodiment of the disclosure, the keywords included in the keyword list 1030 may be displayed based on the order in which the searches were performed. Based on the order in which the searches were performed, the display apparatus 100 may display the keywords such that keywords that were searched for earlier are displayed toward the top of the keyword list 1030. For example, when searches were performed in the order of a first keyword, a second keyword, and a third keyword, the display apparatus 100 may display the keywords in the keyword list 1030 in the order of the first keyword, the second keyword, and the third keyword.

According to an embodiment, based on the order in which the searches were performed, the display apparatus 100 may display the keywords such that keywords that were searched for more recently are displayed toward the top of the keyword list 1030. For example, when searches were performed in the order of a first keyword, a second keyword, and a third keyword, the display apparatus 100 may display the keywords in the keyword list 1030 in the order of the third keyword, the second keyword, and the first keyword.

The display apparatus 100 may display a hashtag before each keyword, such that the keywords may be readily distinguished, but the disclosure is not limited thereto. For example, the display apparatus 100 may display the keywords in the form of a bubble user interface. However, the disclosure is not limited thereto, and the keywords may be displayed in various forms.

According to an embodiment of the disclosure, the number of keywords displayed in the keyword list 1030 may be preset or may be set based on a user input. In addition, when the keywords included in the keyword list 1030 cannot all be displayed on a single screen, the display apparatus 100 may display keywords that were not previously displayed on the screen, based on an input for horizontally scrolling the keyword list 1030. However, the disclosure is not limited thereto.

The display apparatus 100 according to an embodiment of the disclosure may display a content list including one or more image content items associated with a keyword selected from the keyword list 1030.

For example, referring to FIG. 10, when there is no separate input for selecting a keyword, the display apparatus 100 may select a first keyword displayed at the very beginning of the keyword list 1030. The display apparatus 100 may display the content list 1040 including thumbnails representing one or more image content items associated with the selected first keyword. However, the disclosure is not limited thereto.

The one or more image content items associated with the first keyword may be image content items that are included in a search result previously obtained via a search for the first keyword.

Here, the display apparatus 100 may display the first keyword to be distinguished from the other keywords displayed in the keyword list 1030. For example, the display apparatus 100 may highlight the first keyword or display the first keyword in a different color from the other keywords. However, the disclosure is not limited thereto.

The display apparatus 100 may receive a user input for selecting a keyword in the keyword list 1030, which is different from the currently selected keyword. For example, referring to FIG. 11, in a state in which the first keyword is selected, the display apparatus 100 may receive a user input for selecting a second keyword.

Upon receiving the user input for selecting the second keyword, the display apparatus 100 may highlight the second keyword or display the second keyword in a different color from the other keywords. The display apparatus 100 may display a second content list 1140 including thumbnails representing one or more image content items that are associated with the second keyword and included in a search result previously obtained via a search for the second keyword. However, the disclosure is not limited thereto.

When an input for selecting any one of the thumbnails included in the first content list 1040 or the second content list 1140 displayed in the search history area 1020 is received, the display apparatus 100 may reproduce an image content item corresponding to the selected thumbnail, based on deep link information about the corresponding image content item.

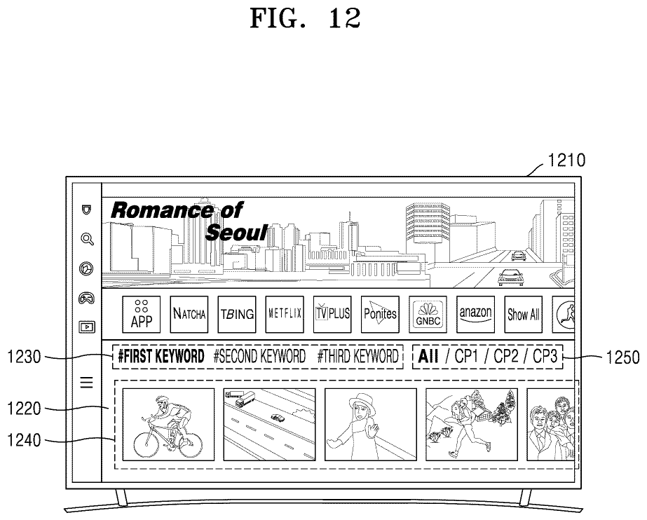

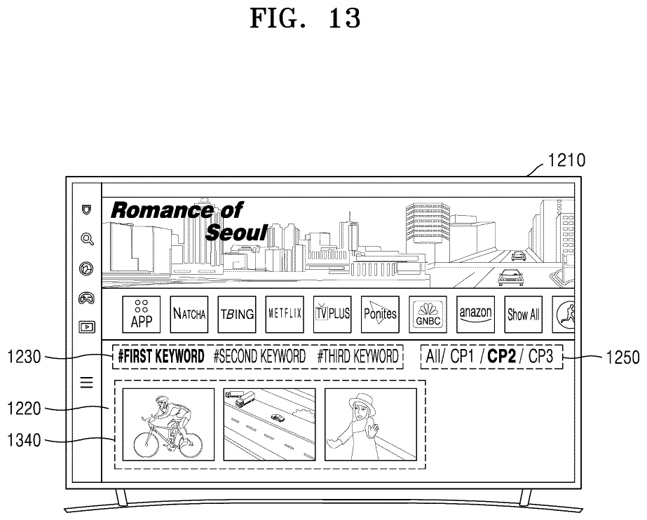

FIGS. 12 and 13 are diagrams illustrating an example in which a display apparatus displays a search history area on a home screen, according to one or more embodiments of the disclosure.

Referring to FIG. 12, when there is a history of searches that have been performed, the display apparatus 100 according to an embodiment of the disclosure may display a search history area 1220 on a home screen 1210.

The search history area 1220 may include keywords that have been searched for by the user, and search results for the keywords. For example, as illustrated in FIG. 12, the search history area 1220 may include a keyword list 1230 including keywords previously searched for by the user, and a content list 1240 including one or more image content items associated with each of the keywords. The one or more image content items associated with each of the keywords may be image content items that are included in a search result previously obtained via a keyword search. The content list 1240 may include thumbnails respectively representing the one or more image content items. However, the disclosure is not limited thereto.

According to an embodiment of the disclosure, the keywords included in the keyword list 1230 may be displayed based on the order in which the searches were performed.

The display apparatus 100 may display a hashtag before each keyword, such that the keywords may be readily distinguished, but the disclosure is not limited thereto. For example, the display apparatus 100 may display the keywords in the form of a bubble user interface. However, the disclosure is not limited thereto, and the keywords may be displayed in various forms.

According to an embodiment of the disclosure, the number of keywords displayed in the keyword list 1230 may be preset or may be set based on a user input. In addition, when the keywords included in the keyword list 1230 cannot all be displayed on a single screen, the display apparatus 100 may display keywords that were not previously displayed on the screen, based on an input for horizontally scrolling the keyword list 1230. However, the disclosure is not limited thereto.

The display apparatus 100 according to an embodiment of the disclosure may display, in the content list 1240, one or more image content items associated with a keyword selected from the keyword list 1230.

For example, referring to FIG. 12, when there is no separate input for selecting a keyword, the display apparatus 100 may select a first keyword displayed at the very beginning of the keyword list 1230. The display apparatus 100 may display the content list 1240 including thumbnails representing one or more image content items associated with the selected first keyword. However, the disclosure is not limited thereto. The one or more image content items associated with the first keyword may be image content items that are included in a search result previously obtained via a search for the first keyword.

Here, the display apparatus 100 may display the first keyword to be distinguished from the other keywords displayed in the keyword list 1230. For example, the display apparatus 100 may highlight the first keyword or display the first keyword in a different color from the other keywords. However, the disclosure is not limited thereto.

The display apparatus 100 according to an embodiment of the disclosure may display, in the search history area 1220, one or more content providers that provide one or more found content items. For example, the display apparatus 100 may display a content provider list including one or more content providers. Referring to FIG. 12, a content provider list 1250 may include texts or items representing all content providers (“All”), a first content provider (“CP1”), a second content provider (“CP2”), and a third content provider (“CP3”). According to an embodiment, the one or more content providers (CP1, CP2, CP3, etc.) may correspond to the one or more applications in the application list.

The content providers included in the content provider list 1250 may be displayed in descending order of the number of content items included in the search result. For example, when the number of content items provided by the first content provider (“CP1”) among the one or more image content items found in relation to the first keyword is greater than the number of content items provided by the second content provider (“CP2”), the display apparatus 100 may display, in the content provider list 1250, the text or item representing the first content provider (“CP1”) ahead of the text or item representing the second content provider (“CP2”). However, the disclosure is not limited thereto.

Referring to FIG. 12, when there is no separate input for selecting a content provider, the display apparatus 100 may select the text or item representing all content providers (“All”) from the content provider list 1250. The display apparatus 100 may display a content list including thumbnails representing one or more image content items found by using the first keyword.

Here, the display apparatus 100 may display, in the content provider list 1250, the text or item representing all content providers (“All”) to be distinguished from the texts or items representing other content providers. For example, the display apparatus 100 may display the text or item representing all content provider (“All”) in a different color from the other texts or items representing other content providers included in the content provider list 1250. However, the disclosure is not limited thereto.

The display apparatus 100 may receive a user input for selecting a content provider in the content provider list 1250, which is different from the currently selected content provider. For example, referring to FIG. 13, in a state in which the text or item representing all content provider (“All”) is selected, the display apparatus 100 may receive a user input for selecting the text or item representing the second content provider (“CP2”).

Upon receiving the user input for selecting the text or item representing the second content provider (“CP2”), the display apparatus 100 may highlight the text or item representing the second content provider (“CP2”) or display the text or item in a different color from the texts or items representing other content providers.

The display apparatus 100 may display a content list 1340 including thumbnails representing the image content items provided by the second content provider (“CP2”) from among the one or more image content items found by using the first keyword.

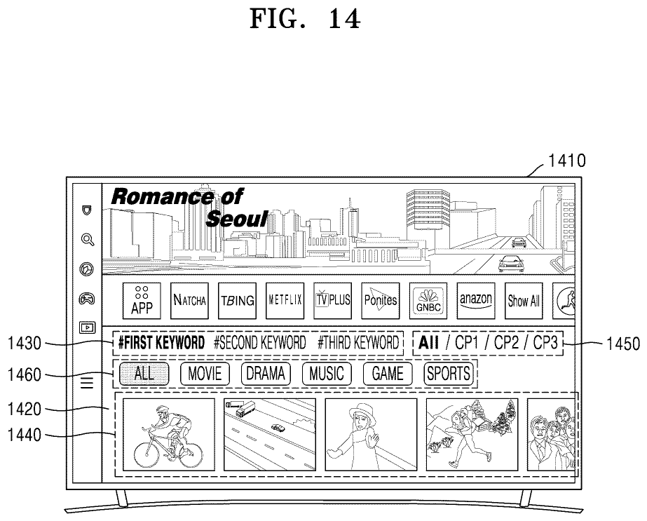

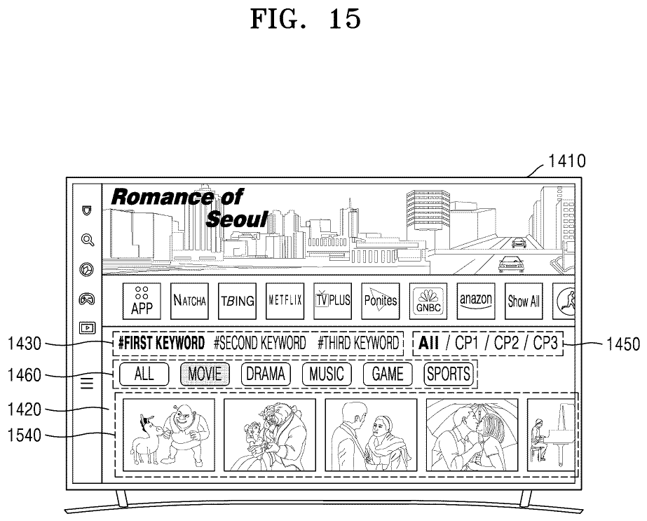

FIGS. 14 and 15 are diagrams illustrating an example in which a display apparatus displays a search history area on a home screen, according to one or more embodiments of the disclosure.

Referring to FIG. 14, when there is a history of searches that have been performed, the display apparatus 100 according to an embodiment of the disclosure may display a search history area 1420 on a home screen 1410.

The search history area 1420 may include keywords that have been searched for by the user, and search results for the keywords. For example, as illustrated in FIG. 14, the search history area 1420 may include a keyword list 1430 including keywords previously searched for by the user, and a content list 1440 including one or more image content items associated with each of the keywords. The one or more image content items associated with each of the keywords may be image content items that are included in a search result previously obtained via a keyword search. The content list 1440 may include thumbnails respectively representing the one or more image content items. However, the disclosure is not limited thereto.

The display apparatus 100 according to an embodiment of the disclosure may display the content list 1440 including thumbnails representing one or more image content items associated with a keyword selected from the keyword list 1430.

For example, referring to FIG. 14, when there is no separate input for selecting a keyword, the display apparatus 100 may select a first keyword displayed at the very beginning of the keyword list 1430, and display the content list 1440 including thumbnails representing one or more image content items associated with the selected first keyword. However, the disclosure is not limited thereto. The one or more image content items associated with the first keyword may be image content items that are included in a search result previously obtained via a search for the first keyword.

The display apparatus 100 according to an embodiment of the disclosure may display, in the search history area 1420, one or more content providers that provide one or more image content items as the search result. For example, the display apparatus 100 may display a content provider list 1450 including one or more content providers. Referring to FIG. 14, the content provider list 1450 may include texts or items representing all content providers (“All”), a first content provider (“CP1”), a second content provider (“CP2”), and a third content provider (“CP3”). According to an embodiment, the one or more content providers (CP1, CP2, CP3, etc.) may correspond to the one or more applications in the application list.

Referring to FIG. 14, when there is no separate input for selecting a content provider, the display apparatus 100 may select the text or item representing all content providers (“All”) from the content provider list 1450. The display apparatus 100 may display a content list including thumbnails representing one or more image content items found by using the first keyword.

The display apparatus 100 according to an embodiment of the disclosure may display, in the search history area 1420, genres of the one or more image content items. For example, the display apparatus 100 may display a genre list 1460 including texts or items representing one or more genres. The genre list 1460 may include texts or items representing all genres, movie, drama, music, game, and sports. The items representing the genres may be displayed in the form of a bubble user interface, but the disclosure is not limited thereto.

Referring to FIG. 14, when there is no separate input for selecting a genre, the display apparatus 100 may select the text or item representing all genres from the genre list 1460. The display apparatus 100 may display, in the content list, all of the one or more content items found by using the first keyword.

Here, the display apparatus 100 may display, in the genre list, the text or item representing all genres to be distinguished from the texts or items representing other genres. For example, the display apparatus 100 may highlight the text or item representing all genre or display the text or item in a different color from the other texts or items representing other genres included in the genre list. However, the disclosure is not limited thereto.

The display apparatus 100 may receive a user input for selecting a genre in the genre list 1460, which is different from the currently selected genre. For example, referring to FIG. 15, in a state in which the text or item representing all genres is selected, the display apparatus 100 may receive a user input for selecting the text or item representing movie.

Upon receiving the user input for selecting the text or item representing movie, the display apparatus 100 may highlight the text or item representing movie or display the text or item in a different color from the texts or items representing other genres.

The display apparatus 100 may display, in a content list 1540, movie content items from among the one or more content items found by using the first keyword. For example, the display apparatus 100 may display, in the content list 1540, content items with genre classification information indicating movie, from among the one or more content items found by using the first keyword. However, the disclosure is not limited thereto.

Although an example of classifying and displaying one or more content items included in previous search results according to genre is described above with reference to FIGS. 14 and 15, the disclosure is not limited thereto. The display apparatus 100 according to an embodiment of the disclosure may classify and display one or more content items based on their content types, attributes, formats, purposes, target users, or the like.

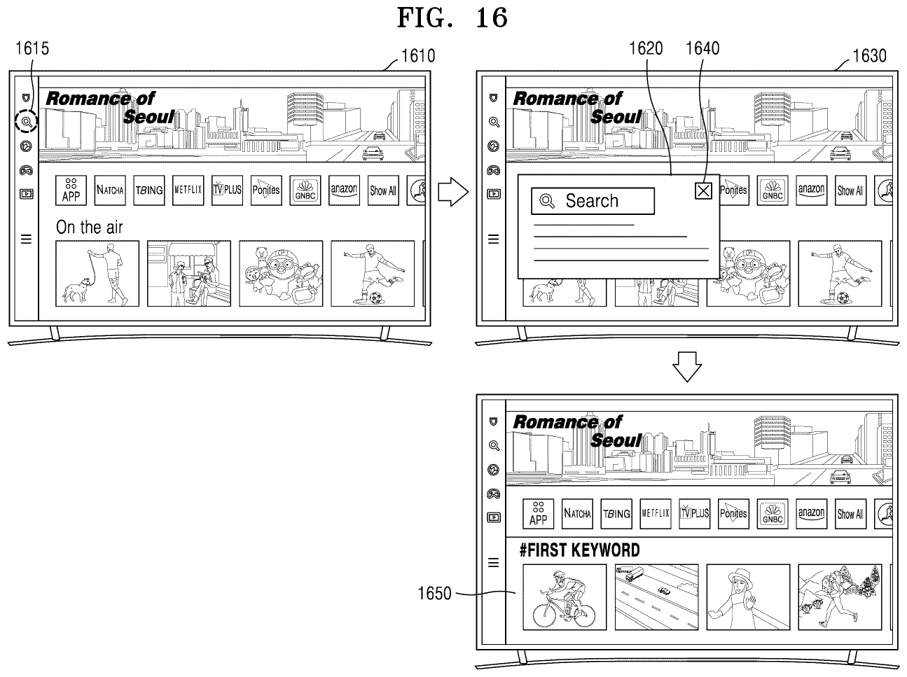

FIG. 16 is a diagram illustrating an example in which a display apparatus displays a search window, according to an embodiment of the disclosure.

Referring to FIG. 16, a home screen 1610 provided by the display apparatus 100 may provide a search function. For example, the home screen 1610 may include a search icon 1615 corresponding to a search function. When the search icon 1615 is selected, the display apparatus 100 may display a search window 1620. According to an embodiment of the disclosure, the search window 1620 may be displayed overlaid on a portion of the home screen 1610. For example, the search window 1620 may be displayed such that it does not obscure a target area 1630. Accordingly, even while a search is being performed, the display apparatus 100 may continuously expose targeted content displayed in the target area 1630 to the user.

Referring to FIG. 16, the search window 1620 may include a keyword window into which a search keyword may be input, a search request button, and the like. In addition, the search window 1620 may include an area that displays a search result after a search for a keyword has been performed, but the disclosure is not limited thereto.

For example, the user may input a first keyword into the search window 1620 and request a search for the first keyword. Based on the request for the search for the first keyword, the display apparatus 100 may perform a search for the first keyword, and obtain or display a search result for the first keyword.

When an input for selecting any one of one or more image content items included in the search result is received, the display apparatus 100 may reproduce the selected image content item.

According to an embodiment of the disclosure, upon receiving an input for selecting a close button 1640 included in the search window 1620, the display apparatus 100 may terminate the display of the search window 1620 and display the home screen 1610 including a search history area 1650. The search result for the first keyword may be displayed in the search history area 1650.

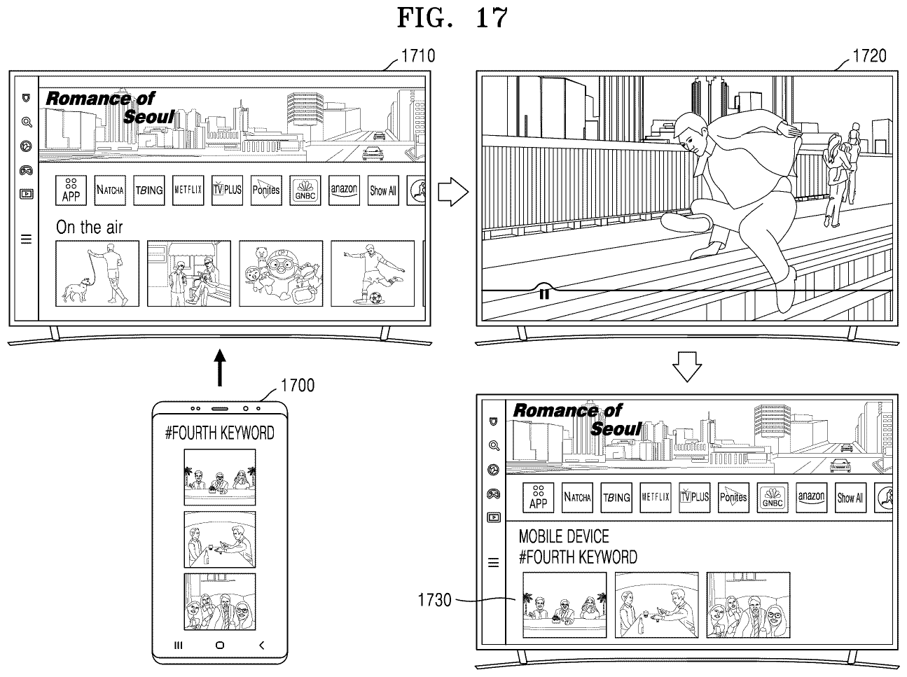

FIG. 17 is a diagram illustrating an example in which a display apparatus displays, in a search history area of a home screen, a result of a search performed by an external electronic device, according to an embodiment of the disclosure.

Referring to FIG. 17, according to an embodiment of the disclosure, the display apparatus 100 and an electronic device 1700 may perform communication.

The electronic device 1700 according to an embodiment of the disclosure may be implemented in various forms such as a mobile phone, a tablet PC, a digital camera, a camcorder, a laptop computer, a desktop computer, an electronic book terminal, a digital broadcast terminal, a PDA, a PMP, a navigation system, an MP3 player, or a wearable device.

The electronic device 1700 according to an embodiment of the disclosure may perform a search for a keyword based on a user input. For example, the electronic device 1700 may receive a keyword and a search request for the keyword, based on a keypad input or a voice input. Based on the keyword and the search request for the keyword, the electronic device 1700 may perform a search for the keyword and obtain a search result. The electronic device 1700 may display the search result. For example, the electronic device 1700 may perform a search for a fourth keyword and display, on a display of the electronic device 1700, a search result for the fourth keyword.

The electronic device 1700 may transmit a control command to the display apparatus 100 such that an image content item, which is selected by the user from among one or more image content items included in the search result for the fourth keyword, is reproduced via the display apparatus 100.

The display apparatus 100 may receive, from the electronic device 1700, reproduction information, deep link information, or the like about the selected image content item, and execute an application for reproducing the selected image content item. By using the executed application, the display apparatus 100 may reproduce the image content item and display a reproduction screen 1720 for the image content item.

When the reproduction of the image content item is terminated or when a preset input is received, the display apparatus 100 may terminate the display of the reproduction screen 1720 for the image content item, and display a home screen 1710 including a search history area 1730.

Here, the fourth keyword and the search result for the fourth keyword may be displayed in the search history area 1730. In addition, the display apparatus 100 may display a result of a keyword search performed by the display apparatus 100, and a result of a keyword search performed by an external device, such that they are distinguished from each other. For example, referring to FIG. 17, the display apparatus 100 may display the search result for the fourth keyword together with text (e.g., “Mobile device”) or an item corresponding to the electronic device 1700. However, the disclosure is not limited thereto.

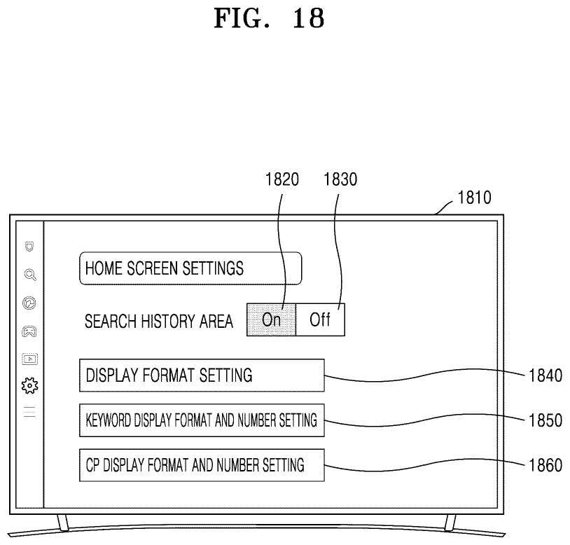

FIG. 18 is a diagram illustrating an example in which a display apparatus displays a home screen setting menu, according to an embodiment of the disclosure.

Referring to FIG. 18, the display apparatus 100 according to an embodiment of the disclosure may display, based on a user input, a menu screen 1810 via which a home screen may be set.

The menu screen 1810 may include a menu for setting whether to display, on a home screen, the search history area according to an embodiment of the disclosure. For example, when the user selects an “On” item 1820 included in the menu screen, the display apparatus 100 may display the search history area on the home screen. On the contrary, when the user selects an “Off” item 1830 included in the menu screen 1810, the display apparatus 100 may not display the search history area on the home screen. For example, when the “Off” item 1830 is selected, the display apparatus 100 may display the first home screen on which the search history area is not provided, as described above with reference to FIGS. 3, 4, and 5.

According to an embodiment of the disclosure, the menu screen 1810 may include an item 1840 for setting the display format of the search history area (e.g., the display format of a content list), an item 1850 for setting the display format and number of keywords, an item 1860 for setting the display format and number of content providers, and the like. By using the item 1840 for setting the display of the search history area, the user may set the format in which keywords for which searches have been performed, and content items associated with the keywords are to be displayed.

In addition, by using the item 1850 for setting the display format and number of keywords, the user may set the format in which each search keyword is to be displayed, and the maximum number of keywords to be displayed.

In addition, by using the item 1860 for setting the display format and number of content providers, the user may set the format in which content providers that provide one or more found content items are to be displayed, and the maximum number of content providers to be displayed.

However, the home screen setting menu is not limited to the above examples and may further include items for setting various conditions, display formats, and the like associated with the search history area.

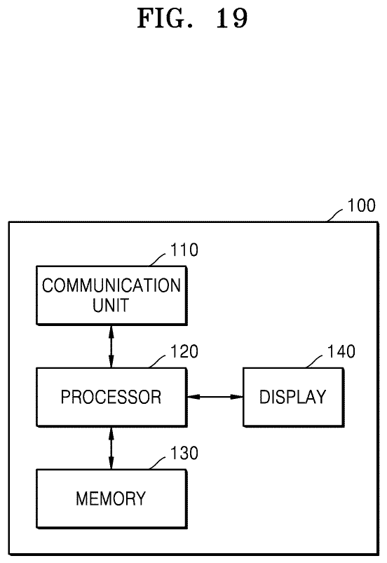

FIG. 19 is a block diagram illustrating a configuration of a display apparatus according to an embodiment of the disclosure.

Referring to FIG. 19, the display apparatus 100 according to an embodiment of the disclosure may include a communication unit 110, a processor 120, memory 130, and a display 140.

According to an embodiment of the disclosure, the communication unit 110 may transmit and receive data or signals to and from an external device (e.g., the control device 400 or the electronic device 1700). For example, the communication unit 110 may be referred to as a communication interface and may be implemented by any one or any combination of a digital modem, a radio frequency (RF) modem, an antenna circuit, a Wi-Fi chip, and related software and/or firmware. For example, the communication unit 110 may include a Wi-Fi module, a Bluetooth module, an infrared communication module, a wireless communication module, a local area network (LAN) module, an Ethernet module, and the like. Here, each communication module may be implemented as at least one hardware chip.

The Wi-Fi module and the Bluetooth module perform communication by using a Wi-Fi scheme and a Bluetooth scheme, respectively. In a case in which the Wi-Fi module or the Bluetooth module is used, various pieces of connection information, such as a service set identifier (SSID) or a session key, may be first transmitted and received, and various pieces of information may be then transmitted and received after a communication connection is established by using the connection information. The wireless communication module may include at least one communication chip configured to perform communication according to various wireless communication standards, such as Zigbee, 3^{rd} Generation (3G), 3^{rd} Generation Partnership Project (3GPP), Long-Term Evolution (LTE), LTE Advanced (LTE-A), 4^{th} Generation (4G), 5^{th} Generation (5G), or the like.

The communication unit 110 according to an embodiment of the disclosure may receive, from the control device 400, a control signal or control command corresponding to a user input (e.g., an input of a key or button of the control device).

The communication unit 110 according to an embodiment of the disclosure may receive, from the electronic device 1700, a request for reproduction of an image content item. Here, the image content item may be an image content item included in a result of a keyword search performed by the electronic device 1700. The communication unit 110 may receive reproduction information, deep link information, or the like about the image content item.

In addition, the communication unit 110 may receive the result of the keyword search performed by the electronic device 1700.

The processor 120 according to an embodiment of the disclosure performs functions of controlling the overall operation of the display apparatus 100, controlling a signal flow between internal components of the display apparatus 100, and processing data.

The processor 120 may include a single core, dual cores, triple cores, quad cores, or cores corresponding to a multiple thereof. In addition, the processor 120 may include a plurality of processors. For example, the processor 120 may include a main processor and a sub-processor.

In addition, the processor 120 may include at least one of a central processing unit (CPU), a graphics processing unit (GPU), or a video processing unit (VPU). Alternatively, according to an embodiment of the disclosure, the processor 120 may be implemented as a system on a chip (SoC) into which at least one of a CPU, a GPU, or a VPU is integrated. Alternatively, the processor 120 may further include a neural processing unit (NPU).

The memory 130 according to an embodiment of the disclosure may store various types of data, programs, or applications for driving and controlling the display apparatus 100.

In addition, the program stored in memory 130 may include one or more instructions. The program (e.g., the one or more instructions) or application stored in the memory 130 may be executed by the processor 120.

The processor 120 according to an embodiment of the disclosure may execute the one or more instructions stored in the memory 130 to control the display 140 to display a home screen. According to an embodiment of the disclosure, the home screen is a menu screen provided by the display apparatus 100, and may be displayed as a full screen or on a portion of a screen. The home screen may include a target area that displays targeted content, a menu area that displays functions or menus provided by the display apparatus 100, an application list indicating one or more applications installed or installable on the display apparatus 100, a content list including recommended content and recently viewed content, etc. However, the disclosure is not limited thereto.

According to an embodiment of the disclosure, a search menu representing a search function may be displayed in a menu area of the home screen. According to an embodiment of the disclosure, the processor 120 may execute one or more instructions stored in the memory 130 to control the display 140 to display a search screen, based on a user input for selecting the search menu.

According to an embodiment of the disclosure, the processor 120 may execute one or more instructions stored in the memory 130 to perform a search for an input keyword to obtain a search result for the keyword, and control the display 140 to display, on the search screen, the search result for the keyword.

According to an embodiment of the disclosure, the processor 120 may execute one or more instructions stored in the memory 130 to control the display 140 to display the search screen to be overlaid on the home screen.

According to an embodiment of the disclosure, the processor 120 may execute one or more instructions stored in the memory 130 to control the display 140 to display the search result for the keyword. For example, the search result for the keyword may include one or more image content items associated with the keyword.

According to an embodiment of the disclosure, the processor 120 may execute one or more instructions stored in the memory 130 to control the display 140 to display, as thumbnails, the one or more image content items associated with the keyword. A thumbnail may be a small image representing image content and may be used for preview purposes. In addition, a thumbnail may be an image that allows a viewer to check an outline of the corresponding content, and may include an image representing a key scene of the image content. However, the disclosure is not limited thereto.

According to an embodiment of the disclosure, the processor 120 may receive a user input for selecting a first image content item from among the one or more image content items included in the search result. For example, the processor 120 may receive an input involving selecting a thumbnail corresponding to the first image content item from among one or more thumbnails by using arrow keys included in a control device 400, and pressing a particular key. Alternatively, the processor 120 may receive, from the user, a voice input, a gesture input, or the like for selecting the first image content item. However, the disclosure is not limited thereto.

According to an embodiment of the disclosure, the processor 120 may execute one or more instructions stored in the memory 130 to reproduce the first image content item, based on the user input for selecting the first image content item.

For example, the processor 120 may execute an application corresponding to the first image content item, and reproduce the first image content item by using the executed application. The display apparatus 100 may display a reproduction screen for the first image content item.

According to an embodiment of the disclosure, the processor 120 may execute one or more instructions stored in the memory 130 to monitor, while the application is being executed, whether the reproduction of the first image content item is terminated, or whether a preset user input is received. For example, the preset user input may include at least one of an input for requesting termination of the first image content item, an input corresponding to a ‘go-back’ action (e.g., an input of a return key or a back key), or an input for requesting the home screen.

According to an embodiment of the disclosure, the processor 120 may execute one or more instructions stored in the memory 130 to, based on the reproduction of the first image content item being terminated or based on the preset user input being received, control the display 140 to display the home screen including a search history area.

According to an embodiment of the disclosure, the processor 120 may detect that the reproduction of the first image content item is terminated, or may receive a key input corresponding to a ‘go-back’ action or an input for requesting a home screen during the reproduction of the first image content item. When the reproduction of the first image content item is terminated, or when an input corresponding to a ‘go-back’ action or an input for requesting a home screen is received, the processor 120 may control the display 140 to display the home screen. Here, the home screen may include a search history area. According to an embodiment of the disclosure, the search history area may be an area in which a keyword for which a search has been previously performed, and a search result for the keyword are displayed.

For example, the processor 120 may control the display 140 to display, in the search history area, a keyword list including keywords previously searched for by the user, and a content list including one or more content items associated with the keywords.

According to an embodiment of the disclosure, the processor 120 may execute one or more instructions stored in the memory 130 to, based on a user input for selecting a first keyword included in the keyword list, control the display 140 to display a first content list including one or more image content items associated with the first keyword.

According to an embodiment of the disclosure, the processor 120 may execute one or more instructions stored in the memory 130 to, based on a user input for selecting a second keyword included in the keyword list, control the display 140 to display a second content list including one or more image content items associated with the second keyword.

According to an embodiment of the disclosure, the processor 120 may execute one or more instructions stored in the memory 130 to, based on a user input for selecting a second image content item from among the one or more image content items displayed in the search history area, reproduce the second image content item.

According to an embodiment of the disclosure, the processor 120 may execute one or more instructions stored in the memory 130 to control the display 140 to display, in the search history area, a content provider list including a plurality of content providers.

According to an embodiment of the disclosure, the processor 120 may execute one or more instructions stored in the memory 130 to, based on an input for selecting any one of the plurality of content providers, control the display 140 to display only image content items that are provided by the selected content provider, from among the one or more image content items associated with the keyword.

According to an embodiment of the disclosure, the processor 120 may execute one or more instructions stored in the memory 130 to control the display 140 to display, in the search history area, a genre list including genres of the image content items.

According to an embodiment of the disclosure, the processor 120 may execute one or more instructions stored in the memory 130 to, based on an input for selecting any one of a plurality of genres, control the display 140 to display only image content items that are classified as the selected genre, from among the one or more image content items associated with the keyword.

The display 140 according to an embodiment of the disclosure converts an image signal, a data signal, an on-screen display (OSD) signal, a control signal, or the like, that has been processed by the processor 120, to generate a driving signal. The display 140 may be implemented as a plasma display panel (PDP), a liquid-crystal display (LCD), an organic light-emitting diode (OLED), a flexible display, or a three-dimensional (3D) display. In addition, the display 140 may be configured as a touch screen to be used as both an output device and an input device.

The display 140 according to an embodiment of the disclosure may display a home screen and display a search history area on the home screen, under control of the processor 120. In addition, the display 140 according to an embodiment of the disclosure may display a reproduction screen for an image content item.

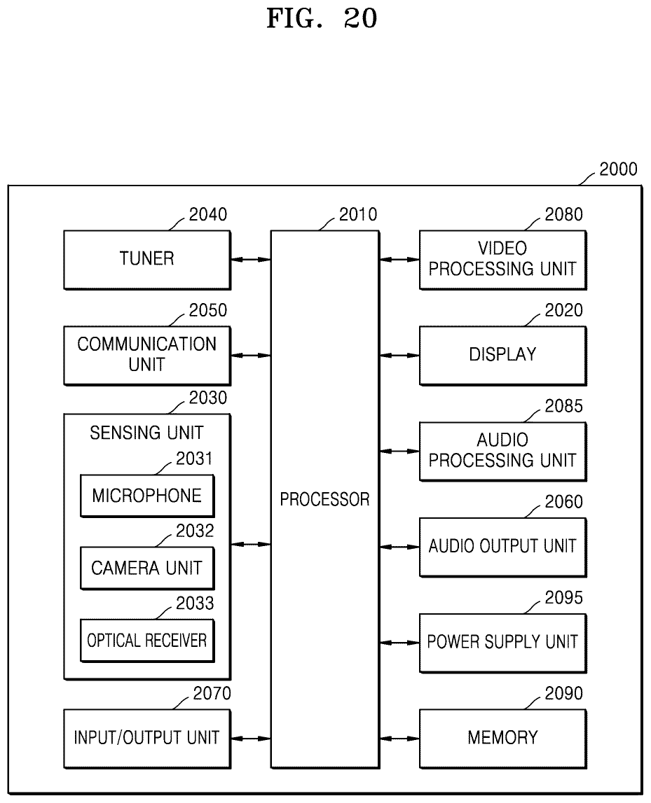

FIG. 20 is a block diagram illustrating a configuration of a display apparatus according to an embodiment of the disclosure.

A display apparatus 2000 of FIG. 20 may be an embodiment of the display apparatus 100 described above with reference to FIGS. 1 to 19.

Referring to FIG. 20, the display apparatus 2000 according to an embodiment of the disclosure may include a tuner 2040, a processor 2010, a display unit 2020, a communication unit 2050, a sensing unit 2030, an input/output unit 2070, a video processing unit 2080, an audio processing unit 2085, an audio output unit 2060, memory 2090, and a power supply unit 2095.

The communication unit 2050 of FIG. 20 may correspond to the communication unit 110 of FIG. 19, the processor 2010 of FIG. 20 may correspond to the processor 120 of FIG. 19, the memory 2090 of FIG. 20 may correspond to the memory 130 of FIG. 19, and the display unit 2020 of FIG. 20 may correspond to the display 140 of FIG. 19. Thus, descriptions identical to those given above will be omitted.

The tuner 2040 according to an embodiment of the disclosure may be tuned to and select only a frequency of a channel desired to be received by the display apparatus 2000 from among a number of radio wave components by performing, for example, amplification, mixing, and resonance on a broadcast signal received in a wired or wireless manner. The broadcast signal includes audio, video, and additional information (e.g., an electronic program guide (EPG)).

The tuner 2040 may receive a broadcast signal from various sources, such as terrestrial, cable, satellite, or Internet broadcasters. The tuner 2040 may also receive a broadcast signal from a source such as an analog or digital broadcaster.

The communication unit 2050 according to an embodiment of the disclosure may receive a control signal or control command from an external control device. For example, the communication unit 2050 may include an IR module capable of transmitting and receiving signals to and from an external control device according to an infrared (IR) communication standard. In detail, the communication unit 2050 may receive, from a control device, a control signal or control command corresponding to a user input (e.g., an input of a key or a button of the control device).

The sensing unit 2030 according to an embodiment of the disclosure may detect a voice, an image, or an interaction of a user, and may include a microphone 2031, a camera unit 2032, and an optical receiver 2033.

The microphone 2031 receives a voice uttered by the user. The microphone 2031 may convert the received voice into an electrical signal and output the electrical signal to the processor 2010. The voice of the user may include, for example, a voice corresponding to a menu or function of the display apparatus 2000. For example, the microphone 2031 may receive a voice of the user corresponding to a display rotation command, convert the received voice into an electrical signal, and output the electrical signal to the processor 2010.

The camera unit 2032 may receive images (e.g., consecutive frames) corresponding to the user's motion including a gesture, within a camera recognition range. The processor 2010 may select a menu to be displayed on the display apparatus 2000 or perform a control operation, based on a result of recognizing the received motion. For example, the processor 2010 may receive images from the camera unit 2032, recognize the user's motion corresponding to display rotation from the received image, and rotate the display accordingly.

The optical receiver 2033 may receive an optical signal (including a control signal) from an external control device through an optical window of a bezel of the display unit 2020. The optical receiver 2033 may receive, from a control device, an optical signal corresponding to a user input (e.g., a touch, a push, a touch gesture, a voice, or a motion). A control signal may be extracted from the received optical signal, under control of the processor 2010.

The input/output unit 2070 according to an embodiment of the disclosure may receive a video (e.g., a moving image), an audio (e.g., a voice or music), and additional information (e.g., an EPG), from the outside of the display apparatus 2000. The input/output unit 2070 may include any one of a high-definition multimedia interface (HDMI) port, a mobile high-definition link (MHL) port, a universal serial bus (USB) port, a display port (DP), a Thunderbolt port, a video graphics array (VGA) port, an RGB port, a D-subminiature (D-SUB) port, a digital visual interface (DVI) port, a component jack, and a PC port.

The processor 2010 performs functions of controlling the overall operation of the display apparatus 2000 and a signal flow between internal components of the display apparatus 2000, and processing data. When a user input is received or a preset and stored condition is satisfied, the processor 2010 may execute an operating system (OS) and various applications stored in the memory 2090.

The processor 2010 may include random-access memory (RAM) to store signals or data input from outside the display apparatus 2000 or to be used as a storage for various operations performed by the display apparatus 2000, read-only memory (ROM) storing a plurality of instructions and/or a control program for controlling the display apparatus 2000, and a processor.

The video processing unit 2080 processes video data received by the display apparatus 2000. The video processing unit 2080 may perform various image processing operations, such as decoding, scaling, noise reduction, frame rate conversion, or resolution conversion, on the video data.

The audio processing unit 2085 processes audio data. The audio processing unit 2085 may perform various processing operations, such as decoding, amplification, or noise removal, on the audio data. In addition, the audio processing unit 2085 may include a plurality of audio processing modules configured to process an audio corresponding to a plurality of pieces of content.

The audio output unit 2060 outputs an audio included in a broadcast signal received through the tuner 2040, under control of the processor 2010. The audio output unit 2060 may output an audio (e.g., a voice or a sound) input through the communication unit 2050 or the input/output unit 2070. In addition, the audio output unit 2060 may output an audio stored in the memory 2090 under control of the processor 2010. The audio output unit 2060 may include at least one of a speaker, a headphone output port, or a Sony/Philips Digital Interface (S/PDIF) output port.

The power supply unit 2095 supplies power input from an external power source, to the internal components of the display apparatus 2000, under control of the processor 2010. In addition, the power supply unit 2095 may supply power output from one or more batteries in the display apparatus 2000, to the internal components, under control of the processor 2010.

The memory 2090 may store various pieces of data, programs, or applications for driving and controlling the display apparatus 2000 under control of the processor 2010. The memory 2090 may include a broadcast receiving module, a channel control module, a volume control module, a communication control module, a speech recognition module, a motion recognition module, an optical receiving module, a display control module, an audio control module, an external input control module, a power control module, a power control module of an external device connected in a wireless manner (e.g., Bluetooth), a speech database (DB), or a motion DB. The modules and the DBs of the memory 2090 may be implemented in the form of software for the display apparatus 2000 to perform a function of controlling broadcast reception, a channel control function, a volume control function, a communication control function, a speech recognition function, a motion recognition function, a light reception control function, a display control function, an audio control function, an external input control function, a power control function, or a power control function of an external device connected in a wireless manner (e.g., Bluetooth). The processor 2010 may perform each function by using the software stored in the memory 2090.

The block diagrams of the display apparatuses 100 and 2000 illustrated in FIGS. 19 and 20 are merely examples. Each of the components illustrated in the block diagrams may be integrated, added, or omitted according to the specification of the display apparatus 100 or 2000 actually implemented. That is, two or more components may be integrated into one component, or one component may be divided into two or more components. In addition, a function performed by each block is for describing embodiments of the disclosure, and its detailed operation or device does not limit the scope of the disclosure.

According to an embodiment of the disclosure, a display apparatus may include a display, memory storing one or more instructions, and at least one processor configured to execute the one or more instructions.

According to an embodiment of the disclosure, the at least one processor may be further configured to execute the one or more instructions to control the display to display a home screen including one or more content lists arranged in a row.

According to an embodiment of the disclosure, the at least one processor may be further configured to execute the one or more instructions to obtain, based on performing a search for a first keyword, a search result for the first keyword, which includes one or more image content items associated with the first keyword.

According to an embodiment of the disclosure, the at least one processor may be further configured to execute the one or more instructions to add, to the home screen as a row, a first content list including the one or more image content items associated with the first keyword, and control the display to display the home screen with the first content list added thereto.

According to an embodiment of the disclosure, the at least one processor may be further configured to execute the one or more instructions to reproduce a first image content item from among the one or more image content items associated with the first keyword.

According to an embodiment of the disclosure, the at least one processor may be further configured to execute the one or more instructions to control, based on reproduction of the first image content item being terminated or based on a preset user input being received, the display to display the home screen with the first content list added thereto.

According to an embodiment of the disclosure, the at least one processor may be further configured to execute the one or more instructions to execute an application for reproducing the first image content item.

According to an embodiment of the disclosure, the at least one processor may be further configured to execute the one or more instructions to reproduce the first image content item by using the application.

According to an embodiment of the disclosure, the at least one processor may be further configured to execute the one or more instructions to monitor, while the application is being executed, whether the reproduction of the first image content item is terminated or whether the preset user input is received.

According to an embodiment of the disclosure, the preset user input may include at least one of an input for requesting termination of the first image content item, an input corresponding to a ‘go-back’ action, or an input for requesting the home screen.

According to an embodiment of the disclosure, the home screen may include a search menu representing a search function.

According to an embodiment of the disclosure, the at least one processor may be further configured to execute the one or more instructions to display a search screen based on a user input for selecting the search menu.

According to an embodiment of the disclosure, the at least one processor may be further configured to execute the one or more instructions to control, based on the search for the first keyword being performed, the display to display, on the search screen, the search result for the first keyword.

According to an embodiment of the disclosure, the at least one processor may be further configured to execute the one or more instructions to control the display to display the search screen to be overlaid on the home screen.

According to an embodiment of the disclosure, the home screen may include a target area.

According to an embodiment of the disclosure, the at least one processor may be further configured to execute the one or more instructions to control the display to display targeted content in the target area.

According to an embodiment of the disclosure, the at least one processor may be further configured to execute the one or more instructions to obtain a search result for a second keyword, which includes one or more image content items associated with the second keyword.

According to an embodiment of the disclosure, the at least one processor may be further configured to execute the one or more instructions to add, to the home screen as a row, a second content list including the one or more image content items associated with the second keyword, and control the display to display the home screen with the second content list added thereto.

According to an embodiment of the disclosure, the at least one processor may be further configured to execute the one or more instructions to control the display to display, on the home screen, a keyword list including the first keyword and the second keyword.

According to an embodiment of the disclosure, the at least one processor may be further configured to execute the one or more instructions to control, based on a user input for selecting the first keyword, the display to display only the first content list without displaying the second content list.

According to an embodiment of the disclosure, the at least one processor may be further configured to execute the one or more instructions to control, based on a user input for selecting the second keyword, the display to display only the second content list without displaying the first content list.

According to an embodiment of the disclosure, the at least one processor may be further configured to execute the one or more instructions to reproduce the second image content item, based on a user input for selecting the second image content item from among the one or more image content items included in the first content list or the second content list.

According to an embodiment of the disclosure, the at least one processor may be further configured to execute the one or more instructions to control the display to display, on the home screen, a content provider list including a plurality of content providers.

According to an embodiment of the disclosure, the at least one processor may be further configured to execute the one or more instructions to control, based on an input for selecting any one of the plurality of content providers, the display to display, in the first content list, only image content items that are provided by the selected content provider, from among the one or more image content items associated with the first keyword.

According to an embodiment of the disclosure, the at least one processor may be further configured to execute the one or more instructions to set, based on a user input, at least one of whether to display, on the home screen, a content list including one or more image content items associated with a searched keyword, a display format of the content list, or a number of content items in the content list.

According to an embodiment of the disclosure, a method of operating a display apparatus may include displaying a home screen including one or more content lists arranged in a row.

According to an embodiment of the disclosure, the method of operating a display apparatus may include obtaining, based on performing a search for a first keyword, a search result for the first keyword, which includes one or more image content items associated with the first keyword.

According to an embodiment of the disclosure, the method of operating a display apparatus may include adding, to the home screen as a row, a first content list including the one or more image content items associated with the first keyword, and displaying the home screen with the first content list added thereto.

According to an embodiment of the disclosure, the method of operating a display apparatus may include reproducing a first image content item from among the one or more image content items associated with the first keyword.

According to an embodiment of the disclosure, the method of operating a display apparatus may include displaying, based on reproduction of the first image content item being terminated or based on a preset user input being received, the home screen with the first content list added thereto.

According to an embodiment of the disclosure, the reproducing of the first image content item may include executing an application for reproducing the first image content item.

According to an embodiment of the disclosure, the reproducing of the first image content item may include reproducing the first image content item by using the application.

According to an embodiment of the disclosure, the method of operating a display apparatus may include monitoring, while the application is being executed, whether the reproduction of the first image content item is terminated or whether the preset user input is received.

According to an embodiment of the disclosure, the preset user input may include at least one of an input for requesting termination of the first image content item or an input corresponding to ‘go-back’, ‘previous’, ‘home screen’, or ‘terminate’.

According to an embodiment of the disclosure, the home screen may include a target area.

According to an embodiment of the disclosure, the method of operating a display apparatus may further include displaying targeted content in the target area.

According to an embodiment of the disclosure, the method of operating a display apparatus may further include obtaining a search result for a second keyword, which includes one or more image content items associated with the second keyword.

According to an embodiment of the disclosure, the method of operating a display apparatus may include adding, to the home screen as a row, a second content list including the one or more image content items associated with the second keyword, and displaying the home screen with the second content list added thereto.

According to an embodiment of the disclosure, the method of operating a display apparatus may include displaying, on the home screen, a keyword list including the first keyword and the second keyword.

According to an embodiment of the disclosure, the method of operating a display apparatus may include displaying, based on a user input for selecting the first keyword, only the first content list without displaying the second content list.

According to an embodiment of the disclosure, the method of operating a display apparatus may include displaying, based on a user input for selecting the second keyword, only the second content list without displaying the first content list.

According to an embodiment of the disclosure, by displaying a search history area on a home screen, the display apparatus may provide a search result for a keyword that has been previously searched for. Accordingly, the user does not need to repeat the search for the same keyword and may quickly find and execute a desired image content item based on a past search result.

According to an embodiment of the disclosure, the display apparatus may execute an application to reproduce an image content item selected from a search result, and when the reproduction of the image content item is terminated or when a preset input is received, the display apparatus may display a search screen or a home screen including previous search results, instead of displaying a home screen of the application. Accordingly, after terminating the reproduction of the image content item selected from the search result, the user may quickly and easily check other content items included in the search result.

According to an embodiment of the disclosure, the display apparatus may display the search history area on the home screen and display the home screen when reproduction of an image content item is terminated, thereby increasing the exposure of targeted content displayed on the home screen.

The method of operating a display device according to an embodiment of the disclosure may be embodied as program commands executable by various computer devices, and recorded on a computer-readable medium. The computer-readable medium may include program commands, data files, data structures, or the like separately or in combinations. The program commands to be recorded on the medium may be specially designed and configured for the disclosure or may be well-known to and be usable by those skill in the art of computer software. Examples of the computer-readable recording medium include magnetic media such as hard disks, floppy disks, or magnetic tapes, optical media such as a compact disc ROM (CD-ROM) or a digital video disc (DVD), magneto-optical media such as a floptical disk, and hardware devices such as ROM, RAM, or flash memory, which are specially configured to store and execute program commands. Examples of program commands include not only machine code, such as code made by a compiler, but also high-level language code that is executable by a computer by using an interpreter or the like.

In addition, the method of operating a display apparatus according to embodiments of the disclosure may be provided in a computer program product. The computer program product may be traded as commodities between sellers and buyers.

The computer program product may include a software (S/W) program and a computer-readable recording medium storing the S/W program. For example, the computer program product may include a product in the form of a S/W program electronically distributed (e.g., a downloadable application) through a manufacturer of an electronic device or an electronic market (e.g., Google Play Store or App Store). For electronic distribution, at least part of the S/W program may be stored in a storage medium or temporarily generated. In this case, the storage medium may be a storage medium of a server of the manufacturer or a server of the electronic market, or a relay server that temporarily stores the S/W program.

The computer program product may include a storage medium of a server or a storage medium of a client device, in a system consisting of the server and the client device. Alternatively, when there is a third device (e.g., a smart phone) communicatively connected to the server or the client device, the computer program product may include a storage medium of the third device. Alternatively, the computer program product may include a S/W program, which is transmitted from the server to the client device or the third device or transmitted from the third device to the client device.

In this case, any one of the server, the client device, and the third device may execute the computer program product to perform the method according to embodiments of the disclosure. Alternatively, two or more of the server, the client device, and the third device may execute the computer program product to execute the method according to embodiments of the disclosure in a distributed manner.

For example, the server (e.g., a cloud server, an artificial intelligence server) may execute the computer program product stored in the server to control the client device communicatively connected to the server to perform the method according to embodiments of the disclosure.

Although embodiments of the disclosure have been described above in detail, the scope of the disclosure is not limited thereto, and various modifications and alterations by those of skill in the art using the basic concept of the disclosure defined in the following claims also fall within the scope of the disclosure.

What is claimed is:

1. A display apparatus comprising:
a display;
memory storing one or more instructions; and
at least one processor configured to execute the one or more instructions to:
control the display to display a home screen comprising one or more content lists arranged in a row,
based on a search for a first keyword, obtain a search result for the first keyword, the search result comprising one or more image content items corresponding to the first keyword,
add, to the one or more content lists arranged in the row, a first content list comprising the one or more image content items corresponding to the first keyword, and
control the display to display the home screen comprising the first content list.

2. The display apparatus of claim 1, wherein the at least one processor is further configured to execute the one or more instructions to:
reproduce a first image content item among the one or more image content items corresponding to the first keyword, and
based on the reproduction of the first image content item being terminated or based on a preset user input being received, control the display to display the home screen comprising the first content list.

3. The display apparatus of claim 2, wherein the at least one processor is further configured to execute the one or more instructions to:
execute an application corresponding to the first image content item,
reproduce the first image content item based on executing the application, and
in a state in which the application is being executed, identify whether the reproduction of the first image content item is terminated or whether the preset user input is received.

4. The display apparatus of claim 2, wherein the preset user input comprises at least one of an input requesting termination of the first image content item, an input requesting to return to a previous screen, or an input requesting the home screen.

5. The display apparatus of claim 1, wherein the home screen comprises a search menu corresponding to a search function, and
wherein the at least one processor is further configured to execute the one or more instructions to:
display a search screen based on a user input selecting the search menu, and
based on the search for the first keyword, control the display to display, on the search screen, the search result for the first keyword.

6. The display apparatus of claim 5, wherein the at least one processor is further configured to execute the one or more instructions to control the display to overlay the search screen on the home screen.

7. The display apparatus of claim 1, wherein the home screen comprises a target area, and
wherein the at least one processor is further configured to execute the one or more instructions to control the display to display targeted content in the target area.

8. The display apparatus of claim 1, wherein the at least one processor is further configured to execute the one or more instructions to:
obtain a second search result for a second keyword, the second search result comprising one or more image content items corresponding to the second keyword,
add, to the one or more content lists arranged in the row, a second content list comprising the one or more image content items corresponding to the second keyword, and
control the display to display the home screen comprising the second content list.

9. The display apparatus of claim 8, wherein the at least one processor is further configured to execute the one or more instructions to:
control the display to display, on the home screen, a keyword list comprising the first keyword and the second keyword,
based on a user input selecting the first keyword, control the display to display only the first content list, among the first content list and the second content list, and
based on a user input selecting the second keyword, control the display to display only the second content list, among the first content list and the second content list.

10. The display apparatus of claim 9, wherein the at least one processor is further configured to execute the one or more instructions to:
reproduce a second image content item, based on a user input selecting the second image content item among the one or more image content items comprised in the first content list or the second content list.

11. The display apparatus of claim 1, wherein the at least one processor is further configured to execute the one or more instructions to:
control the display to display, on the home screen, a content provider list comprising a plurality of content providers, and
based on an input selecting a content provider among the plurality of content providers, control the display to display, in the first content list, only image content items corresponding to the selected content provider, among the one or more image content items corresponding to the first keyword.

12. The display apparatus of claim 1, wherein the at least one processor is further configured to execute the one or more instructions to:
based on a user input, set at least one of:
whether to display, on the home screen, a content list comprising one or more image content items corresponding to a searched keyword,
a display format of the content list, or
a number of content items in the content list.

13. A method of operating a display apparatus, the method comprising:
displaying a home screen including one or more content lists arranged in a row;
based on a search for a first keyword, obtaining a search result for the first keyword, the search result including one or more image content items corresponding to the first keyword;
adding, to the one or more content lists arranged in the row, a first content list including the one or more image content items corresponding the first keyword; and
displaying the home screen including the first content list.

14. The method of claim 13, further comprising:
reproducing a first image content item among the one or more image content items corresponding to the first keyword; and
based on the reproduction of the first image content item being terminated or based on a preset user input being received, displaying the home screen including the first content list.

15. The method of claim 14, wherein the reproducing the first image content item comprises:
executing an application corresponding to the first image content item; and
reproducing the first image content item based on executing the application, and
wherein the method further comprises, in a state in which the application is being executed, identifying whether the reproduction of the first image content item is terminated or whether the preset user input is received.

16. The method of claim 14, wherein the preset user input includes at least one of an input requesting termination of the first image content item, an input requesting to return to a previous screen, or an input requesting the home screen.

17. The method of claim 13, wherein the home screen includes a target area, and
wherein the method further comprises displaying targeted content in the target area.

18. The method of claim 13, further comprising:
obtaining a second search result for a second keyword, the second search result including one or more image content items corresponding to the second keyword;
adding, to the one or more content lists arranged in the row, a second content list including the one or more image content items corresponding to the second keyword; and
displaying the home screen including the second content list.

19. The method of claim 18, further comprising:
displaying, on the home screen, a keyword list including the first keyword and the second keyword;
based on a user input selecting the first keyword, displaying only the first content list, among the first content list and the second content list; and
based on a user input selecting the second keyword, displaying only the second content list, among the first content list and the second content list.

20. A non-transitory computer-readable recording medium having stored therein a program that, when executed by one or more or more processors, executes a method comprising:
displaying a home screen including one or more content lists arranged in a row;
based on a search for a first keyword, obtaining a search result for the first keyword, the search result including one or more image content items corresponding to the first keyword;
adding, to the one or more content lists arranged in the row, a first content list including the one or more image content items corresponding the first keyword; and
displaying the home screen including the first content list.
